(19) United States
(12) Patent Application Publication
(10) Pub. No.: US 2024/0230971 A9
(43) Pub. Date: Jul. 11, 2024

(54) LENS DEVICE, IMAGING APPARATUS, AND FILTER UNIT

(71) Applicant: FUJIFILM Corporation, Tokyo (JP)

(72) Inventors: Kazuyoshi OKADA, Saitama (JP); Yasunobu KISHINE, Saitama (JP); Yuya HIRAKAWA, Saitama (JP); Koichi TANAKA, Saitama (JP); Takashi KUNUGISE, Saitama (JP); Tatsuro IWASAKI, Saitama (JP)

(73) Assignee: FUJIFILM Corporation, Tokyo (JP)

(21) Appl. No.: 18/403,641

(22) Filed: Jan. 3, 2024

Related U.S. Application Data
(63) Continuation of application No. PCT/JP2022/023586, filed on Jun. 13, 2022.

(30) Foreign Application Priority Data
Jul. 29, 2021 (JP) 2021-123939

(51) Int. Cl. G02B 5/20; G02B 7/00

(52) U.S. Cl. CPC G02B 5/201; G02B 7/006

(57) ABSTRACT

Provided are a lens device, an imaging apparatus, and a filter unit capable of suppressing occurrence of ghosts and flares. The lens device includes a first optical filter and a second optical filter in order from an object side in an optical path. The first optical filter is composed of an optical filter (for example, a band-pass filter) that has a light transmission band in a specific wavelength region. The second optical filter is composed of an optical filter (band-stop filter) that has a light absorption band in a wavelength region which is different from the light transmission band of the first optical filter.

### CROSS-REFERENCE TO RELATED APPLICATIONS

The present application is a Continuation of PCT International Application No. PCT/JP2022/023586 filed on Jun. 13, 2022 claiming priority under 35 U.S.C § 119(a) to Japanese Patent Application No. 2021-123939 filed on Jul. 29, 2021. Each of the above applications is hereby expressly incorporated by reference, in its entirety, into the present application.

### BACKGROUND OF THE INVENTION

### 1. Field of the Invention

The present invention relates to a lens device, an imaging apparatus, and a filter unit.

### 2. Description of the Related Art

JP2014-020791A discloses an imaging apparatus comprising a polarization color filter plate, which has a plurality of translucent regions having different polarization characteristics and color characteristics, and a polarization image sensor.

### SUMMARY OF THE INVENTION

In an embodiment according to a technique of the present disclosure, there are provided a lens device, an imaging apparatus, and a filter unit capable of suppressing occurrence of ghosts and flares.

(1) A lens device comprising, in order from an object side in an optical path: a first optical filter that has a light transmission band in a specific wavelength region; and a second optical filter that has a light absorption band in a wavelength region which is different from the light transmission band of the first optical filter.

(2) The lens device according to (1), in which the first optical filter is a reflective type band-pass filter.

(3) The lens device according to (1) or (2), further comprising, in the optical path: a frame that has a plurality of opening portions, in which the lens device has the first optical filters that are disposed in at least two of the opening portions, and the second optical filters that are disposed in the opening portions in which the first optical filters are disposed.

(4) The lens device according to (3), in which the first optical filters disposed in the opening portions each have a light transmission band different from the first optical filter disposed in at least one opening portion of the other opening portions.

(5) The lens device according to (4), in which the second optical filters disposed in the opening portions each have a light absorption band including the light transmission band of the first optical filter disposed in at least one opening portion of the other opening portions.

(6) The lens device according to (4), in which the frame includes at least three of the opening portions, the lens device has the first optical filters that are disposed in at least three of the opening portions, and the second optical filters that are disposed in the opening portions in which the first optical filters are disposed, and the second optical filter disposed in at least one of the opening portions has a light absorption band including the light transmission band of the first optical filter disposed in the other opening portion.

(7) The lens device according to (4), in which the frame includes at least three of the opening portions, the lens device has the first optical filters that are disposed in at least three of the opening portions, and the second optical filters that are disposed in the opening portions in which the first optical filters are disposed, and the second optical filter disposed in the at least one opening portion is formed by combining a plurality of optical filters having different light absorption bands, and has a light absorption band including the light transmission band of the first optical filter disposed in the other opening portion.

(8) The lens device according to any one of (1) to (7), in which the second optical filter has an absorbance of 0.8 or more at a wavelength at which the absorbance is a peak.

(9) The lens device according to any one of (1) to (8), in which the second optical filter has a transmittance of 0.8 or more at a wavelength at which the transmittance is a peak.

(10) The lens device according to any one of (1) to (9), in which the second optical filter has a reflectance of less than 0.1 at a wavelength at which the reflectance is a peak.

(11) The lens device according to any one of (1) to (10), in which a width of a wavelength, at which an absorbance of the second optical filter is 50% of a peak value, is equal to or greater than 20 nm.

(12) The lens device according to (11), in which a width of a wavelength, at which an absorbance of the second optical filter is 50% of a peak value, is equal to or greater than 20 nm and equal to or less than 200 nm.

(13) The lens device according to any one of (1) to (12), in which the second optical filter has a layer including a coloring agent.

(14) The lens device according to any one of (1) to (13), in which the second optical filter has a transmittance of 0.8 or more at a wavelength corresponding to a wavelength at which a transmittance of the first optical filter is a peak.

(15) The lens device according to any one of (3) to (7), in which the second optical filters disposed in the opening portions each have an absorbance of 0.8 or more at a wavelength corresponding to a wavelength at which a transmittance of the first optical filter disposed in at least one opening portion of the other opening portions is a peak.

(16) The lens device according to (3), (4), (5), (6), (7), or (15), in which the frame is disposed at a pupil position or near the pupil position.

(17) The lens device according to (3), (4), (5), (6), (7), (15), or (16), further comprising: a polarization filter that is disposed in the opening portion in which the first optical filter is disposed.

(18) An imaging apparatus comprising: the lens device according to (17); and a polarization image sensor that receives light which passes through the lens device.

(19) A filter unit disposed in an optical path of a lens device, the filter unit comprising: a frame that has a plurality of opening portions; first optical filters that are disposed in at least two of the opening portions and each have a light transmission band in a specific wavelength region; and second optical filters that are disposed in the opening portions in which the first optical filters are disposed and each have a light absorption band in a wavelength region which is different from the light transmission bands of the first optical filters.

(20) The filter unit according to (19), in which the first optical filters disposed in the opening portions each have a light transmission band different from the first optical filter disposed in at least one opening portion of the other opening portions.

(21) The filter unit according to (19) or (20), in which the second optical filters disposed in the opening portions each have a light absorption band including the light transmission band of the first optical filter disposed in at least one opening portion of the other opening portions.

(22) The filter unit according to any one of (19) to (21), further comprising: polarization filters that are disposed in the opening portions in which the first optical filters are disposed.

### BRIEF DESCRIPTION OF THE DRAWINGS

FIG. 1 is a diagram showing an example of an imaging lens.

FIG. 2 is a front view showing a schematic configuration of a filter unit.

FIG. 3 is a graph showing an example of absorbance characteristics of a first band-stop filter.

FIG. 4 is a graph showing an example of absorbance characteristics of a second band-stop filter.

FIG. 5 is an explanatory diagram of an effect of the imaging lens.

FIG. 6 is a front view of the filter unit provided in the imaging lens in which a pupil region is divided into three parts.

FIG. 7 is an exploded perspective view of the filter unit shown in FIG. 6.

FIG. 8 is a graph showing an example of absorbance characteristics of a first band-stop filter.

FIG. 9 is a graph showing an example of absorbance characteristics of a second band-stop filter.

FIG. 10 is a graph showing an example of absorbance characteristics of a third band-stop filter.

FIG. 11 is an explanatory diagram of an effect of the imaging lens.

FIG. 12 is a diagram showing another example of a shape of a window portion provided in the filter unit.

FIG. 13 is a graph showing an example of absorbance characteristics of a sharp-cut filter.

FIG. 14 is a graph showing an example of absorbance characteristics of a second optical filter in a case where the band-stop filter and the sharp-cut filter are combined to form one second optical filter.

FIG. 15 is a graph showing an example of absorbance characteristics of the second optical filter.

FIG. 16 is a graph showing an example of transmittance characteristics of the second optical filter.

FIG. 17 is a graph showing another example of transmittance characteristics of the second optical filter.

FIG. 18 is a graph showing an example of reflectance characteristics of the second optical filter.

FIG. 19 is a graph showing an example of transmittance characteristics of the second optical filter used in combination with the first optical filter.

FIG. 20 is a graph showing another example of transmittance characteristics of the second optical filter used in combination with the first optical filter.

FIG. 21 is a graph showing an example of transmittance characteristics of the band-stop filter that is used in combination with the band-pass filter in a third window portion.

FIG. 22 is a graph showing an example of transmittance characteristics in a case where the sharp-cut filter is used as the second optical filter.

FIG. 23 is an exploded perspective view of a filter unit provided in an imaging lens for a polarization type multispectral camera system.

FIG. 24 is a diagram showing an example of a polarization filter provided in each window portion of the filter unit.

FIG. 25 is a diagram showing a schematic configuration of the multispectral camera system.

FIG. 26 is a diagram showing an example of arrangement of a pixel and a polarizer in a polarization image sensor.

FIG. 27 is a diagram showing an example of a hardware configuration of a signal processing device.

FIG. 28 is a block diagram of a main function of the signal processing device.

### DESCRIPTION OF THE PREFERRED EMBODIMENTS

Hereinafter, preferred embodiments of the present invention will be described in detail with reference to the accompanying drawings.

[Imaging Lens]

Here, a case where the present invention is applied to an imaging lens, particularly a pupil division imaging lens, will be described as an example. The pupil division imaging lens is a lens in which a pupil region is divided into a plurality of regions. The pupil division imaging lens is used, for example, in a multispectral camera system. The multispectral camera system will be described later.

[Configuration]

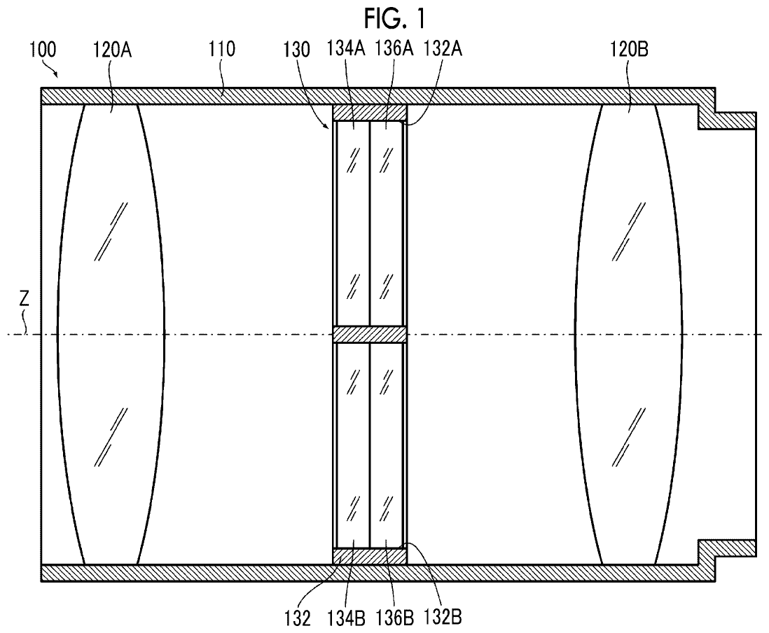

FIG. 1 is a diagram showing an example of the imaging lens.

An imaging lens 100 according to the present embodiment is a pupil division imaging lens in which the pupil region is divided into two parts. The imaging lens 100 is an example of the lens device.

As shown in FIG. 1, the imaging lens 100 comprises a lens barrel 110, a plurality of lens groups 120A and 120B, and a filter unit 130.

The lens barrel 110 has a cylindrical shape. The lens groups 120A and 120B and the filter unit 130 are disposed at predetermined positions in the lens barrel 110.

The lens groups 120A and 120B each are composed of at least one lens. FIG. 1 shows, for convenience, only two lens groups 120A and 120B. Hereinafter, the two lens groups 120A and 120B are distinguished, as necessary. The lens group 120A disposed on the front side of the filter unit 130 will be referred to as a first lens group. The lens group 120B disposed on the rear side of the filter unit 130 will be referred to as a second lens group. It should be noted that the “front side” means the “object side”, and the “rear side” means the “image side”.

The filter unit 130 is disposed in an optical path. More specifically, the filter unit 130 is disposed at the pupil position or near the pupil position in the imaging lens 100. It should be noted that the vicinity of the pupil position means a region satisfying the following expression.

|d|<φ/(2 tan θ)

Here, θ is a maximum principal ray angle at the pupil position (the principal ray angle is an angle between the principal ray and the optical axis),
φ is a pupil diameter, and
   |d| is a distance from the pupil position.

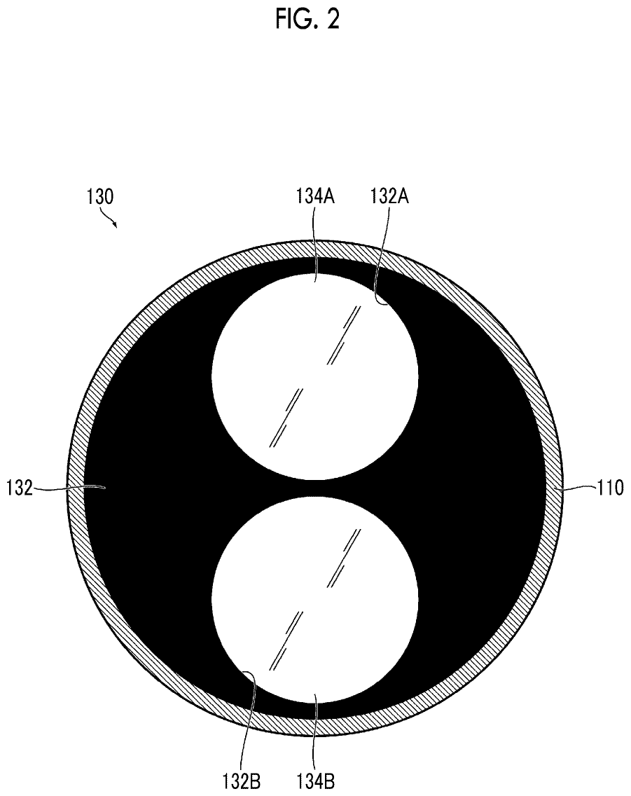

FIG. 2 is a front view showing a schematic configuration of the filter unit.

The filter unit 130 is composed of a filter frame 132 and an optical filter which is held by the filter frame 132.

The filter frame 132 has a plate-like shape corresponding to an inner peripheral shape of the lens barrel 110, and has a plurality of window portions. As shown in FIG. 2, the filter frame 132 according to the present embodiment has a disk shape and has two window portions 132A and 132B. The filter frame 132 is an example of the frame.

The two window portions 132A and 132B each are formed of a circular opening portion and are symmetrically disposed with the optical axis Z interposed therebetween. The window portions 132A and 132B are examples of the opening portions. Hereinafter, as necessary, the window portion 132A will be referred to as a first window portion 132A and the window portion 132B will be referred to as a second window portion 132B. In such a manner, the two window portions 132A and 132B are distinguished.

In the imaging lens 100, the filter frame 132 is disposed at the pupil position or near the pupil position, and thus the pupil region is divided into a plurality of regions. That is, the optical path is divided into a plurality of parts. In the present embodiment, the pupil region is divided into two regions. That is, the optical path is divided into two parts.

Band-pass filters (BPF) 134A and 134B and band-stop filters (BSF) 136A and 136B are disposed on the respective window portions 132A and 132B in order from an object side (front side) along the optical axis Z.

Hereinafter, as necessary, the band-pass filter 134A, which is disposed in the first window portion 132A, will be referred to as a first band-pass filter 134A, and the band-pass filter 134B, which is disposed in the second window portion 132B, will be referred to as a second band-pass filter 134B. In such a manner, the band-pass filters 134A and 134B, which are disposed in the respective window portions 132A and 132B, are distinguished. Further, the band-stop filter 136A, which is disposed in the first window portion 132A, will be referred to as a first band-stop filter 136A, and the band-stop filter 136B, which is disposed in the second window portion 132B, will be referred to as a second band-stop filter 136B. In such a manner, the band-stop filters 136A and 136B, which are disposed in the respective window portions 132A and 132B, are distinguished.

The band-pass filter is an optical filter which transmits only the light in a specific wavelength region by transmitting the light in the specific wavelength region with high efficiency and efficiently blocking the other light. The band-pass filters 134A and 134B, which are disposed in the respective window portions 132A and 132B, have light transmission bands which are different from each other. The light transmission band of the first band-pass filter 134A will be referred to as a first light transmission band Λ1. Further, the light transmission band of the second band-pass filter 134B will be referred to as a second light transmission band Λ2 (Λ1≠Λ2). In the present embodiment, the second light transmission band Λ2 is set to be on a longer wavelength side than the first light transmission band Λ1. The band-pass filters 134A and 134B are examples of the first optical filter.

Incidentally, the band-pass filter includes a reflective type band-pass filter and an absorptive type band-pass filter. The reflective type band-pass filter has a function of reflecting light in a certain band and transmitting the other band. On the other hand, the absorptive type band-pass filter has a function of absorbing a certain band and transmitting the other bands. The reflective type band-pass filter has an advantage that a narrow light transmission band can be realized and transition from the transmission band to the transmission blocking band can be made to rarely occur. Therefore, in a case where the imaging lens 100 is used in the multispectral camera, it is preferable to use the reflective type band-pass filter. In the imaging lens 100 of the present embodiment, the reflective type band-pass filter is used.

The band-stop filter is an optical filter which attenuates light in a specific wavelength region (stop band) to a very low level and transmits light in most of the other wavelengths with a small intensity loss. Therefore, the band-stop filter has a property opposite to the band-pass filter. The band-stop filter is also referred to as a band-rejection filter (BRF), a band elimination filter (BEF), a band-blocking filter, a notch filter, or the like. The band-stop filters 136A and 136B are examples of the second optical filter.

In the present embodiment, an absorptive type band-stop filter is used as the band-stop filter. The absorptive type band-stop filter has a light absorption band in a specific wavelength region and inhibits the transmission of light in the light absorption band through absorption.

The band-stop filter is composed of, for example, an optical filter comprising, on a transparent substrate, a layer including a coloring agent material which absorbs light in a specific wavelength region. By using the coloring agent material, required transmittance characteristics, absorbance characteristics, and reflectance characteristics can be obtained. Further, the band-stop filter made of the coloring agent material is easily laminated by thinning. In a case of combining a plurality of coloring agent materials, desired transmittance characteristics, absorbance characteristics, and reflectance characteristics can be obtained.

The first band-stop filter 136A and the second band-stop filter 136B have the following absorbance characteristics.

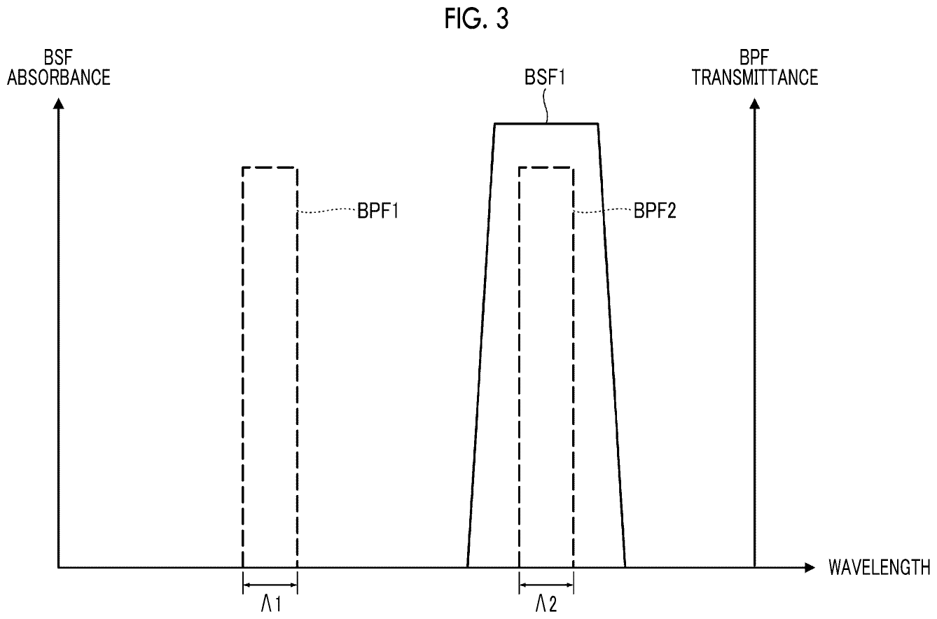

FIG. 3 is a graph showing an example of the absorbance characteristics of the first band-stop filter.

In the drawing, a solid line graph represented by the reference numeral BSF1 indicates the absorbance characteristics of the first band-stop filter 136A.

In addition, in the drawing, a broken line graph represented by the reference numeral BPF1 indicates the transmittance characteristics of the first band-pass filter 134A. Further, a broken line graph represented by the reference numeral BPF2 indicates the transmittance characteristics of the second band-pass filter 134B.

As shown in FIG. 3, the first band-stop filter 136A has characteristics of transmitting light in a wavelength region (first light transmission band Λ1) which is transmitted through at least the first band-pass filter 134A. On the other hand, the first band-pass filter 136A has characteristics of absorbing light in a wavelength region (second light transmission band Λ2) which is transmitted through at least the second band-pass filter 134B.

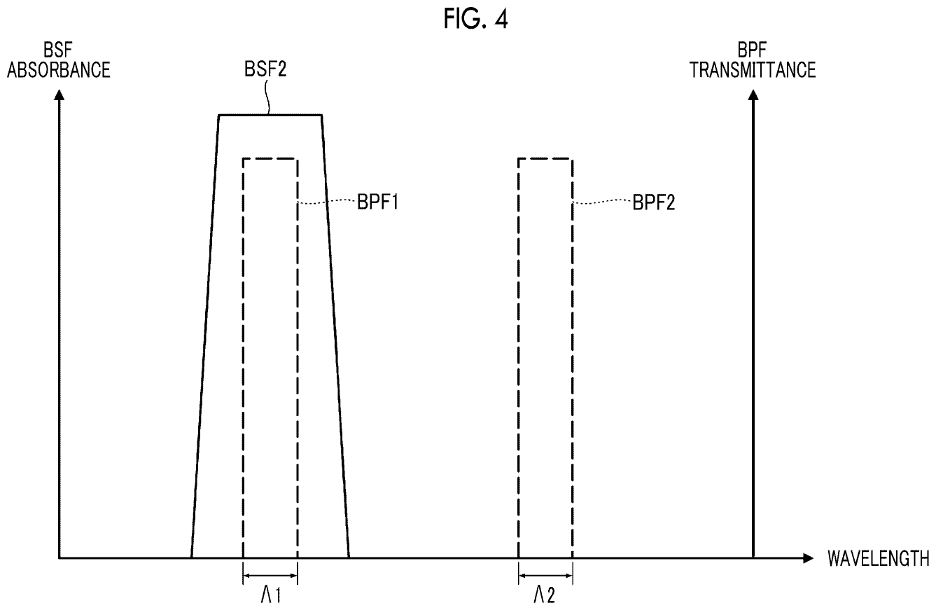

FIG. 4 is a graph showing an example of the absorbance characteristics of the second band-stop filter.

In the figure, a solid line graph represented by the reference numeral BSF2 indicates the absorbance characteristics of the second band-stop filter 136B.

In addition, in the drawing, a broken line graph represented by the reference numeral BPF1 indicates the transmittance characteristics of the first band-pass filter 134A. Further, a broken line graph represented by the reference numeral BPF2 indicates the transmittance characteristics of the second band-pass filter 134B.

As shown in FIG. 4, the second band-stop filter 136B has characteristics of transmitting light having the wavelength region (second light transmission band Λ2) which is transmitted through at least the second band-pass filter 134B. Meanwhile, the second band-stop filter 136B has characteristics of absorbing light having the wavelength region (first light transmission band Λ1) which is transmitted through the first band-pass filter 134A.

As described above, the band-stop filters, which are disposed in the respective window portions, have characteristics of transmitting light having the wavelength region which is transmitted through the band-pass filters disposed in at least the same window portion. On the other hand, the band-stop filters have characteristics of absorbing light having the wavelength region which is transmitted through the band-pass filter disposed in at least one of the other window portions.

Consequently, the band-stop filter disposed in each window portion has a light absorption band in a wavelength region which is different from the light transmission band of the band-pass filter disposed in the same window portion. For example, as shown in FIG. 3, the first band-stop filter 136A has a light absorption band in a wavelength region which is different from the first light transmission band Λ1. Further, as shown in FIG. 4, the second band-stop filter 136B has a light absorption band in a wavelength region which is different from the second light transmission band Λ2.

Further, the band-stop filter disposed in each window portion has a light absorption band including a light transmission band of the band-pass filter disposed in at least one of the other window portions. For example, as shown in FIG. 3, the first band-stop filter 136A has a light absorption band including the second light transmission band Λ2. Further, as shown in FIG. 4, the second band-stop filter 136B has a light absorption band including the first light transmission band Λ1.

[Effects]

Next, an effect of the imaging lens 100 of the present embodiment configured as described above will be described.

First, for comparison, an effect thereof in a case where only the band-pass filter is disposed in each window portion will be described. That is, an effect thereof in a case where there is no band-stop filter will be described.

A pupil division imaging lens such as the imaging lens 100 of the present embodiment has a property that optical paths divided in a pupil region are combined again on the image sensor.

The light, which passes through the first window portion 132A, reaches the image sensor in a state where the light is restricted within a wavelength region Λ1 by the first band-pass filter 134A. Meanwhile, a part of the light is reflected by a lens (second lens group 120B) on a rear side with respect to the first band-pass filter 134A, the image sensor, and the like. Then, the part of the reflected light is incident into the second window portion 132B. The light, which is incident into the second window portion 132B, is reflected again by the second band-pass filter 134B, which is disposed in the second window portion 132B, and then reaches the image sensor. Here, the wavelength region Λ1 of the light, which is reflected by the second band-pass filter 134B, is different from the light transmission band (second light transmission band Λ2) of the second band-pass filter 134B. Therefore, the light is reflected substantially 100%. As a result, strong ghosts and flares occur.

The same applies to the light which passes through the second window portion 132B. The light, which passes through the second window portion 132B, reaches the image sensor in a state where the light is restricted within a wavelength region Λ2 by the second band-pass filter 134B. Meanwhile, a part of the light is reflected by the lens (second lens group 120B) on the rear side with respect to the second band-pass filter 134B, the image sensor, and the like. Then, the part of the reflected light is incident into the first window portion 132A. The light, which is incident into the first window portion 132A, is reflected again by the first band-pass filter 134A disposed on the first window portion 132A and then reaches the image sensor. Here, the wavelength region Λ2 of the light, which is reflected by the first band-pass filter 134A, is different from the light transmission band (first light transmission band Λ1) of the first band-pass filter 134A. Therefore, the light is reflected substantially 100%. As a result, strong ghosts and flares occur.

As described above, in the configuration in which only the band-pass filter is disposed in each window portion, the light, which passes through one window portion, is incident into the other window portion and is reflected again. As a result, strong ghosts and flares occur.

An anti-reflection film is generally used as means for reducing ghosts and flares. Meanwhile, the anti-reflection film improves the transmittance to reduce the reflectance. Therefore, for example, in a case where the anti-reflection film with the wavelength region Λ1 is provided to the second band-pass filter 134B, the light having the wavelength region Λ1 is transmitted. As a result, the light transmission band of the second band-pass filter 134B transmits both the wavelength region Λ1 and the wavelength region Λ2. Thus, it is difficult to realize a desired transmittance characteristic (a transmittance characteristic that transmits only the wavelength region Λ1).

Next, an effect of the imaging lens 100 according to the present embodiment will be described.

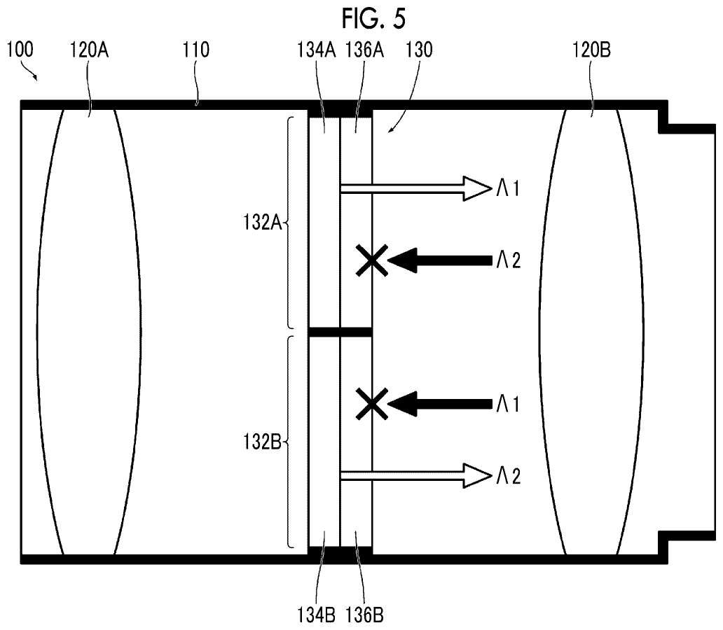

FIG. 5 is an explanatory diagram of the effect of the imaging lens.

The light, which is incident into the imaging lens 100, has an optical path that is divided into three parts by the filter unit 130, passes through the first window portion 132A and the second window portion 132B, and reaches the image sensor (not shown in the drawing).

The light, which is incident into the first window portion 132A, first passes through the first band-pass filter 134A. The light is restricted within the wavelength region Λ1 by passing through the first band-pass filter 134A. Next, the light passes through the first band-stop filter 136A. The first band-stop filter 136A absorbs the light having the wavelength region Λ2 but transmits the light having the wavelength region Λ1. Therefore, the light having the wavelength region Λ1, which passes through the first band-pass filter 134A, passes through the first band-stop filter 136A as it is.

In a similar manner, the light, which is incident into the second window portion 132B, first passes through the second band-pass filter 134B. The light is restricted within the wavelength region Λ2 by passing through the second band-pass filter 134B. Next, the light passes through the second band-stop filter 136B. The second band-stop filter 136B absorbs the light having the wavelength region Λ1 and transmits the light having the wavelength region Λ2. Therefore, the light having the wavelength region Λ2, which passes through the second band-pass filter 134B, passes through the second band-stop filter 136B as it is.

A part of the light, which passes through the first window portion 132A and the second window portion 132B, is reflected by the lens (second lens group 120B) or the like in the process in which the light reaches the image sensor. Further, a part of the light reaching the image sensor is reflected by the image sensor.

The light having the wavelength region Λ1, which passes through the first window portion 132A and is reflected by the lens, the image sensor, or the like, is also incident into the second window portion 132B. Meanwhile, the second band-stop filter 136B is disposed in the second window portion 132B. As described above, the second band-stop filter 136B transmits the light having the wavelength region Λ2 and absorbs the light having the wavelength region Λ1. Therefore, even in a case where the light having the wavelength region Λ1, which is reflected by the lens, the image sensor, or the like, is incident into the second window portion 132B, the light is absorbed before reaching the second band-pass filter 134B. Consequently, it is possible to suppress re-reflection of the light having the wavelength region Λ1, which is reflected by the lens, the image sensor, or the like, from the second band-pass filter 134B.

The same applies to a case where the light having the wavelength region Λ2, which passes through the second window portion 132B, is reflected by the lens, the image sensor, or the like and is incident into the first window portion 132A. The light is absorbed by the first band-stop filter 136A, which is disposed in the first window portion 132A, before reaching the first band-pass filter 134A. Therefore, it is possible to suppress re-reflection from the first band-pass filter 134A.

As described above, according to the imaging lens 100 of the present embodiment, even in a case where the light which passes through one window portion is reflected by the lens, the image sensor, or the like and is incident into the other window portion, the light can be absorbed by the band-stop filters 136A and 136B provided in the respective window portions. Thus, it is possible to suppress re-reflection from the band-pass filters 134A and 134B, and it is possible to suppress occurrence of ghosts and flares.

[Modification Example of Imaging Lens]

(1) Number of Divisions of Pupil Region

In the above-mentioned embodiment, the case where the pupil region is divided into two regions has been described as an example, but the number of divisions of the pupil region is not limited thereto. It is preferable to appropriately set the number in accordance with the use application and the like. Hereinafter, an imaging lens in which the pupil region is divided into three parts will be described as an example.

In the imaging lens in which the pupil region is divided into three parts, a configuration of the filter unit is different from that in the imaging lens 100 of the above-mentioned embodiment in which the pupil region is divided into two parts. Consequently, only the configuration of the filter unit will be herein described.

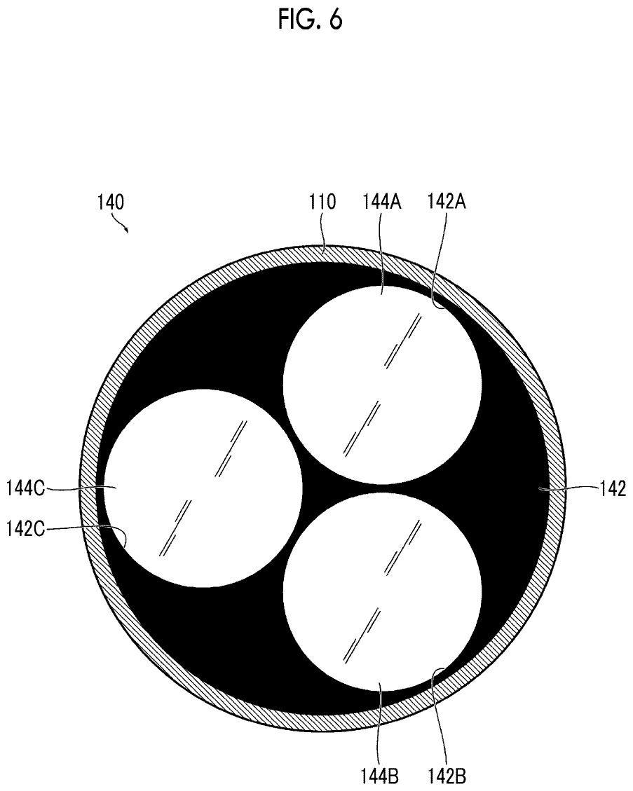

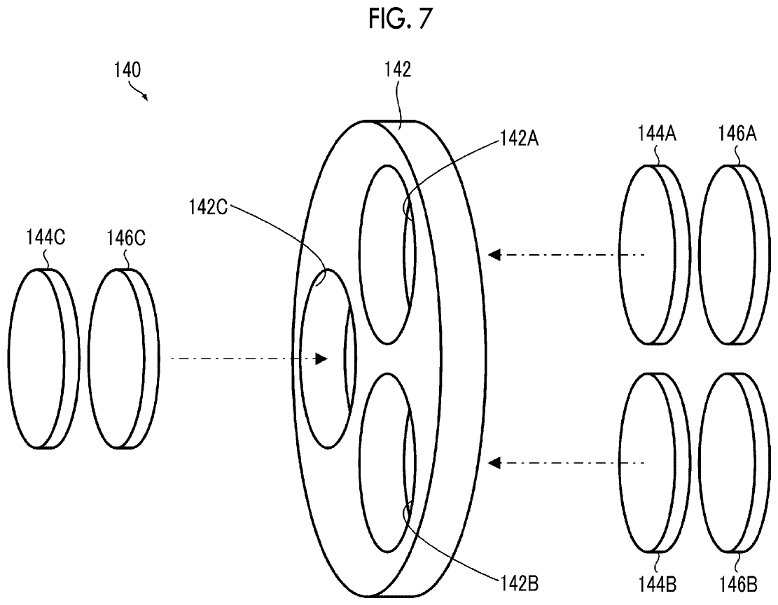

FIG. 6 is a front view of the filter unit provided in the imaging lens in which the pupil region is divided into three parts. Further, FIG. 7 is an exploded perspective view of the filter unit shown in FIG. 6.

As shown in FIGS. 6 and 7, the filter unit 140 of the present example comprises three window portions 142A, 142B, and 142C in a filter frame 142. The window portions 142A, 142B, and 142C are disposed at regular intervals on a concentric circle about the optical axis. Hereinafter, as necessary, the window portion 142A will be referred to as a first window portion 142A, the window portion 142B will be referred to as a second window portion 142B, and the window portion 142C will be referred to as a third window portion 142C. In such a manner, the three window portions 142A, 142B, and 142C are distinguished. In the imaging lens 100, the pupil region is divided into three regions by disposing the filter frame 142 at the pupil position or near the pupil position. That is, the optical path is divided into three parts.

The band-pass filters 144A, 144B, and 144C and the band-stop filters 146A, 146B, and 146C are respectively disposed in the window portions 142A, 142B, and 142C. In the filter unit 140 of the present example, the band-pass filters 144A, 144B, and 144C and the band-stop filters 146A, 146B, and 146C are disposed in order from the object side (front side) along the optical axis Z.

Hereinafter, as necessary, the band-pass filter 144A, which is disposed in the first window portion 142A, will be referred to as a first band-pass filter 144A, the band-pass filter 144B, which is disposed in the second window portion 142B, will be referred to as a second band-pass filter 144B, and the band-pass filter 144C, which is disposed in the third window portion 142C, will be referred to as a third band-pass filter 144C. In such a manner, the band-pass filters 144A, 144B, and 144C, which are disposed in the respective window portions 142A, 142B, and 142C, are distinguished. Further, the band-stop filter 146A, which is disposed in the first window portion 142A, will be referred to as the first band-stop filter 146A, the band-stop filter 146B, which is disposed in the second window portion 142B, will be referred to as the second band-stop filter 146B, and the band-stop filter 146C, which is disposed in the third window portion 142C, will be referred to as a third band-stop filter 146C. In such a manner, the band-stop filters 146A, 146B, and 146C, which are disposed in the respective window portions 142A, 142B, and 142C, are distinguished.

The band-pass filters 144A, 144B, and 144C, which are disposed in the respective window portions 142A, 142B, and 142C, have light transmission bands different from each other. The light transmission band of the first band-pass filter 144A will be referred to as a first light transmission band Λ1. Further, the light transmission band of the second band-pass filter 144B will be referred to as a second light transmission band Λ2 (Λ1≠Λ2). Furthermore, the light transmission band of the third band-pass filter 144C will be referred to as a third light transmission band Λ3 (Λ1≠Λ3, Λ2≠Λ3). In the present example, the third light transmission band Λ3 is set on a longer wavelength side than the second light transmission band Λ2. Further, the second light transmission band Λ2 is set to be on a longer wavelength side than the first light transmission band Λ1. Further, the reflective type band-pass filters are used as the band-pass filters 144A, 144B, and 144C.

An absorptive type band-stop filter is used as the band-stop filters 146A, 146B, and 146C. The band-stop filters 146A, 146B, and 146C, which are disposed in the respective window portions 142A, 142B, and 142C, respectively have the following absorbance characteristics.

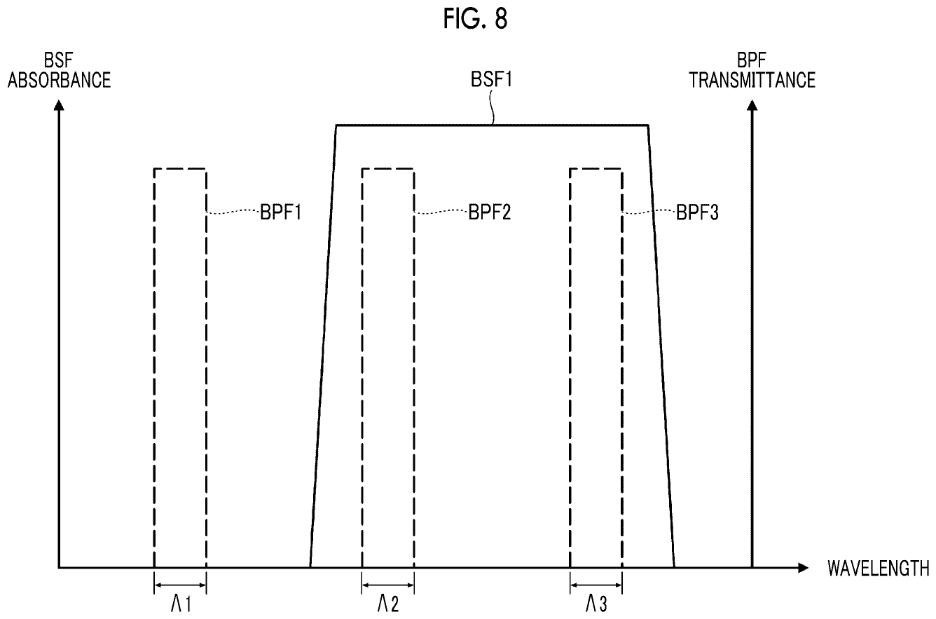

FIG. 8 is a graph showing an example of the absorbance characteristics of the first band-stop filter.

In the drawing, a solid line graph represented by the reference numeral BSF1 indicates the absorbance characteristics of the first band-stop filter 146A.

In addition, in the drawing, a broken line graph represented by the reference numeral BPF1 indicates the transmittance characteristics of the first band-pass filter 144A. Further, a broken line graph represented by the reference numeral BPF2 indicates the transmittance characteristics of the second band-pass filter 144B. Furthermore, a broken line graph represented by the reference numeral BPF3 indicates the transmittance characteristics of the third band-pass filter 144C.

As shown in FIG. 8, the first band-stop filter 146A has characteristics of transmitting light in the wavelength region (first light transmission band Λ1) which is transmitted through at least the first band-pass filter 144A. Meanwhile, the first band-stop filter 146A has characteristics of absorbing the light having the wavelength region (second light transmission band Λ2) which is transmitted through at least the second band-pass filter 144B and the light having the wavelength region (third light transmission band Λ3) which is transmitted through the third band-pass filter 144C.

The first band-stop filter 146A can be realized by, for example, one coloring agent material. That is, the wavelength region (first light transmission band Λ1) where transmission is performed by the first band-stop filter 136A is not present between two wavelength regions (second light transmission band Λ2 and third light transmission band Λ3) absorbed by the first band-stop filter 136A). Thus, the first band-stop filter 146A can be composed of one coloring agent material. Specifically, a coloring agent material, which absorbs light in the second light transmission band Λ2 and the light in the third light transmission band Λ3, is used.

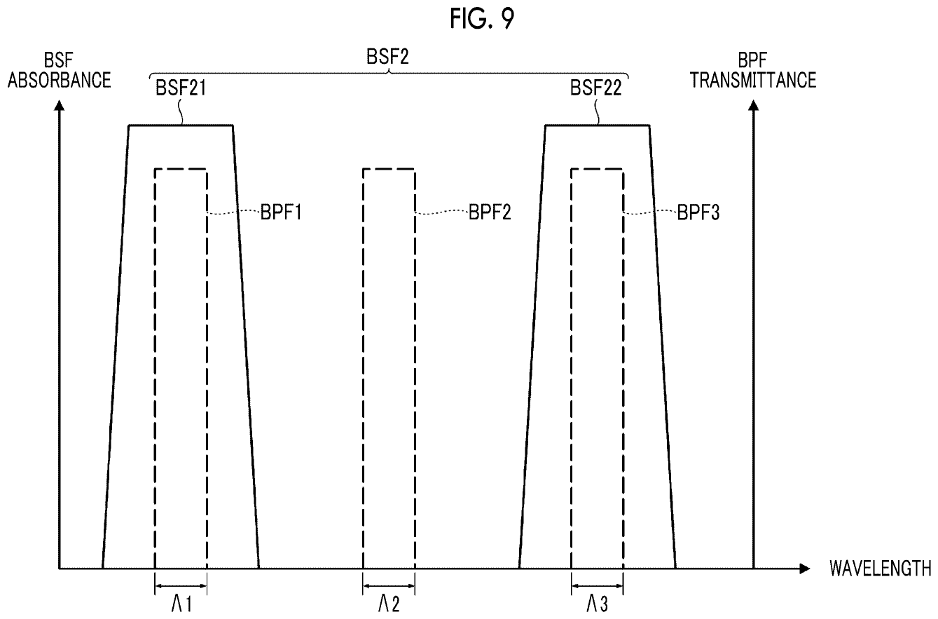

FIG. 9 is a graph showing an example of the absorbance characteristics of the second band-stop filter.

In the drawing, a solid line graph represented by the reference numeral BSF2 indicates the absorbance characteristics of the second band-stop filter 146B.

In addition, in the drawing, a broken line graph represented by the reference numeral BPF1 indicates the transmittance characteristics of the first band-pass filter 144A. Further, a broken line graph represented by the reference numeral BPF2 indicates the transmittance characteristics of the second band-pass filter 144B. Furthermore, a broken line graph represented by the reference numeral BPF3 indicates the transmittance characteristics of the third band-pass filter 144C.

As shown in FIG. 9, the second band-stop filter 146B has characteristics of transmitting light in the wavelength region (second light transmission band Λ2) which is transmitted through at least the second band-pass filter 144B. Meanwhile, the second band-stop filter 146B has characteristics of absorbing the light having the wavelength region (first light transmission band Λ1) which is transmitted through at least the first band-pass filter 144A and the light having the wavelength region (third light transmission band Λ3) which is transmitted through the third band-pass filter 144C.

The second band-stop filter 146B is composed of, for example, a combination of two band-stop filters. Specifically, a band-stop filter having a desired absorbance characteristics is realized as a whole by combining a band-stop filter (first second band-stop filter) that absorbs light in the wavelength region (first light transmission band Λ1) which is transmitted through the first band-pass filter 144A and a band-stop filter (second second band-stop filter) that absorbs light having the wavelength region (the third light transmission band Λ3) which is transmitted through the third band-pass filter 144C. In such a case, for example, the first second band-stop filter is composed of a coloring agent material which absorbs the light in the first light transmission band Λ1. Further, the second second band-stop filter is composed of a coloring agent material which absorbs light in the third light transmission band Λ3. In FIG. 9, a solid line graph represented by the reference numeral BSF21 indicates the absorbance characteristics of the first second band-stop filter. Further, a solid line graph represented by the reference numeral BSF22 indicates absorbance characteristics of the second second band-stop filter.

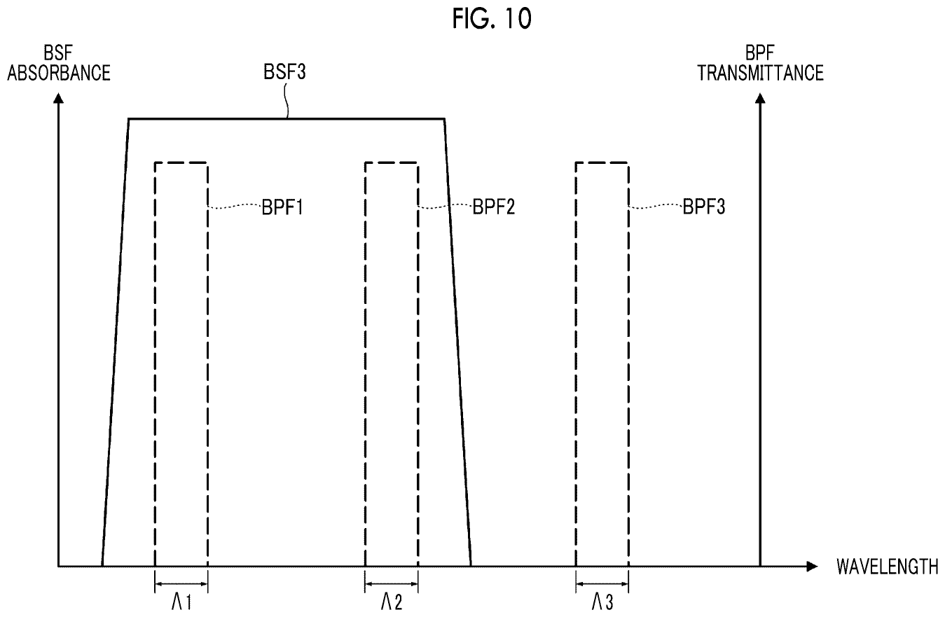

FIG. 10 is a graph showing an example of the absorbance characteristics of the third band-stop filter.

In the drawing, a solid line graph represented by the reference numeral BSF3 shows the absorbance characteristics of the third band-stop filter 146C.

In addition, in the drawing, a broken line graph represented by the reference numeral BPF1 indicates the transmittance characteristics of the first band-pass filter 144A. Further, a broken line graph represented by the reference numeral BPF2 indicates the transmittance characteristics of the second band-pass filter 144B. Furthermore, a broken line graph represented by the reference numeral BPF3 indicates the transmittance characteristics of the third band-pass filter 144C.

As shown in FIG. 10, the third band-stop filter 146C has characteristics of transmitting light in a wavelength region (third light transmission band Λ3) which is transmitted through at least the third band-pass filter 144C. Meanwhile, the third band-stop filter 146C has characteristics of absorbing the light having the wavelength region (first light transmission band Λ1) which is transmitted through at least the first band-pass filter 144A and the light having the wavelength region (second light transmission band Λ2) which is transmitted through the second band-pass filter 144B.

The third band-stop filter 146C can also be realized using one coloring agent material. That is, in a case where a coloring agent material which absorbs the light in the first light transmission band Λ1 and the second light transmission band Λ2 is used, the light absorption filter can be composed of one coloring agent material.

As described above, the band-stop filters, which are disposed in the respective window portions, have characteristics of transmitting the light having the wavelength region which is transmitted through the band-pass filters disposed in at least the same window portion. On the other hand, the band-stop filters have characteristics of absorbing light having the wavelength region which is transmitted through the band-pass filter disposed in at least one of the other window portions. Therefore, as shown in FIG. 8, the first band-stop filter 146A has a light absorption band in a wavelength region which is different from the first light transmission band Λ1, while has a light absorption band in a wavelength region including the second light transmission band Λ2 and the third light transmission band Λ3. Further, as shown in FIG. 9, the second band-stop filter 146B has a light absorption band in a wavelength region which is different from the second light transmission band Λ2, while has a light absorption band in a wavelength region including the first light transmission band Λ1 and the third light transmission band Λ3. Further, as shown in FIG. 10, the third band-stop filter 146C has a light absorption band in a wavelength region which is different from the third light transmission band Λ3, while has a light absorption band in a wavelength region including the first light transmission band Λ1 and the second light transmission band Λ2.

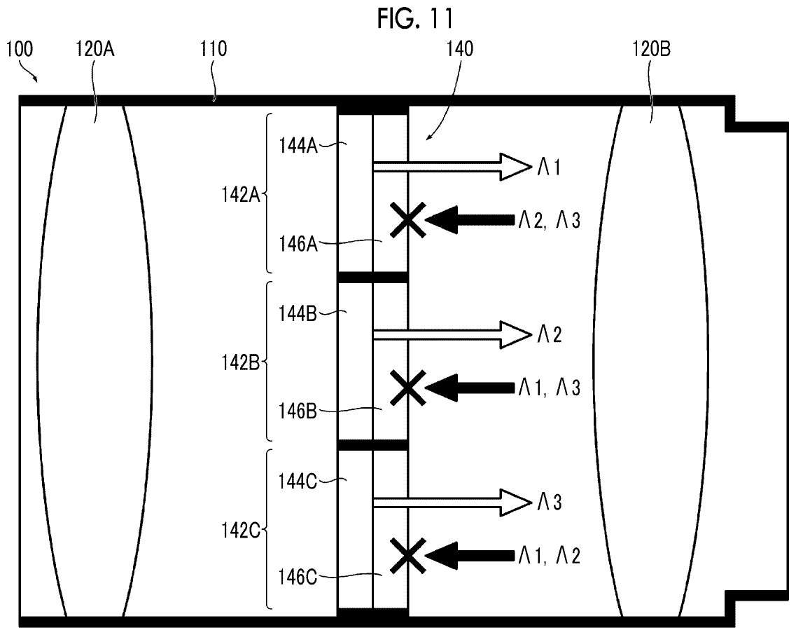

FIG. 11 is an explanatory diagram of the effect of the imaging lens.

Through the filter unit 140, the light, which is incident into the imaging lens 100, passes through the first window portion 142A, the second window portion 142B, and the third window portion 142C, and reaches the image sensor (not shown in the drawing).

The light, which is incident into the first window portion 142A, first passes through the first band-pass filter 144A. The light is restricted within the wavelength region Λ1 by passing through the first band-pass filter 144A. Next, the first band-stop filter 146A passes through the first band-stop filter 146A. The first band-stop filter 146A absorbs the light having the wavelength region Λ2 and the wavelength region Λ3, but transmits the light having the wavelength region Λ1. Therefore, the light having the wavelength region Λ1, which passes through the first band-pass filter 144A, passes through the first band-stop filter 146A as it is.

The light, which is incident into the second window portion 142B, also first passes through the second band-pass filter 144B. The light is restricted within the wavelength region Λ2 by passing through the second band-pass filter 144B. Then, the second band-stop filter 146B passes through the second band-stop filter 146B. The second band-stop filter 146B absorbs the light having the wavelength region Λ1 and the wavelength region Λ3, but transmits the light having the wavelength region Λ2. Therefore, the light having the wavelength region Λ2, which passes through the second band-pass filter 144B, passes through the second band-stop filter 146B as it is.

The light, which is incident into the third window portion 142C, also first passes through the third band-pass filter 144C. The light is restricted within the wavelength region Λ3 by passing through the third band-pass filter 144C. Then, the linearly polarized light passes through the third band-stop filter 146C. The third band-stop filter 146C absorbs the light having the wavelength region Λ1 and the wavelength region Λ2, but transmits the light having the wavelength region Λ3. Therefore, the light having the wavelength region Λ3, which passes through the third band-pass filter 144C, passes through the third band-stop filter 146C as it is.

In the light which passes through the first window portion 142A, the second window portion 142B, and the third window portion 142C, a part of the light is reflected by the lens (second lens group 120B) or the like in the process in which the light reaches the image sensor. Further, a part of the light reaching the image sensor is reflected by the image sensor.

The light having the wavelength region Λ1, which passes through the first window portion 142A and is reflected by the lens, the image sensor, or the like, is also incident into the second window portion 142B and the third window portion 142C. However, the second band-stop filter 146B and the third band-stop filter 146C are respectively disposed in the second window portion 142B and the third window portion 142C. As described above, the second band-stop filter 146B, which is disposed in the second window portion 142B, transmits the light having the wavelength region Λ2 but absorbs the light having the wavelength region Λ1 and the wavelength region Λ3. Therefore, even in a case where the light having the wavelength region Λ1, which is reflected by the lens, the image sensor, or the like, is incident into the second window portion 142B, the light is absorbed before reaching the second band-pass filter 144B. Consequently, it is possible to suppress re-reflection of the light having the wavelength region Λ1 reflected by the lens, the image sensor, or the like from the second band-pass filter 144B. Further, the third band-stop filter 146C, which is disposed in the third window portion 142C, transmits the light having the wavelength region Λ3 but absorbs the light having the wavelength region Λ1 and the wavelength region Λ2. Therefore, even in a case where light having the wavelength region Λ1, which is return light due to reflection, is incident into the third window portion 142C, the light is absorbed before reaching the third band-pass filter 144C. Consequently, it is possible to suppress re-reflection of the light having the wavelength region Λ1, which is the return light due to the reflection, by the third band-pass filter 144C.

The same applies to a case where the light having the wavelength region Λ2, which passes through the second window portion 142B, is reflected by the lens, the image sensor, or the like and is incident into the first window portion 142A and the third window portion 142C. In a case where the light having the wavelength region Λ2, which is return light due to reflection, is incident into the first window portion 142A, the light is absorbed by the first band-stop filter 146A before reaching the first band-pass filter 144A. Consequently, it is possible to suppress re-reflection of the light having the wavelength region Λ2 by the first band-pass filter 144A. Further, in a case where the light having the wavelength region Λ2 is incident into the third window portion 142C, the light is absorbed by the third band-stop filter 146C before reaching the third band-pass filter 144C. Consequently, it is possible to suppress re-reflection of the light having the wavelength region Λ2 by the third band-pass filter 144C.

The same applies to a case where the light having the wavelength region Λ3, which passes through the third window portion 142C, is reflected by the lens, the image sensor, or the like and is incident into the first window portion 142A and the second window portion 142B. In a case where the light having the wavelength region Λ3, which is return light due to reflection, is incident into the first window portion 142A, the light is absorbed by the first band-stop filter 146A before reaching the first band-pass filter 144A. Therefore, it is possible to suppress re-reflection of the light having the wavelength region Λ3 by the first band-pass filter 144A. Further, in a case where the light having the wavelength region Λ3 is incident into the second window portion 142B, the light is absorbed by the second band-stop filter 146B before reaching the second band-pass filter 144B. Consequently, it is possible to suppress re-reflection of the light having the wavelength region Λ3 by the second band-pass filter 144B.

As described above, according to the imaging lens 100 of the present embodiment, even in a case where the light, which passes through one window portion, is reflected by the lens, the image sensor, or the like and is incident into the other window portion, the light can be absorbed by the band-stop filters 146A and 146B provided in the respective window portions. Thus, it is possible to suppress re-reflection from the band-pass filters 144A and 144B, and it is possible to suppress occurrence of ghosts and flares.

(2) Shape of Window Portion

In the above-mentioned embodiment, a shape of the window portion (opening portion shape) provided in the filter unit is a circular shape, but the shape of the window portion is not limited thereto.

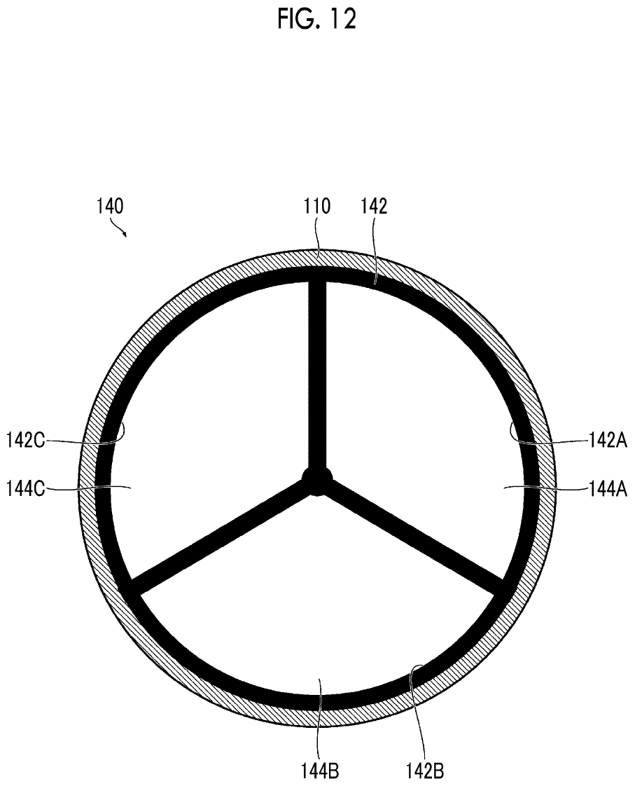

FIG. 12 is a diagram showing another example of the shape of the window portion provided in the filter unit.

In the drawing, a disk-shaped filter frame 142 is divided into three equal parts in the circumferential direction to provide window portions 142A, 142B, and 142C each having a fan-like opening portion shape. The band-pass filters and the band-stop filters each having a fan shape are disposed in the respective window portions 142A, 142B, and 142C.

(3) Configurations of Band-Pass Filters and Band-Stop Filters

The functions of the band-pass filters and the band-stop filters can also be realized by one optical filter. For example, a layer or a film having a function of the band-pass filter is provided on one surface of the transparent substrate, and a layer or a film having a function of the band-stop filter is provided on the other surface of the transparent substrate. Thereby, one optical filter can be realized to have functions of the band-pass filters and the band-stop filters.

In a case where the band-pass filter and the band-stop filter are composed of separate optical filters, it is preferable that the two optical filters are disposed without an air layer interposed therebetween. In such a case, for example, the optical filters can be cemented by optical contact or the like and disposed to be integrated.

(4) Filter Unit

The filter unit may be attachable to and detachable from the lens barrel. Thereby, the filter unit is interchangeable.

Further, a configuration may be adopted in which the optical filters mounted on the respective window portions are interchangeable individually. Thereby, it is possible to freely select the number and combination of wavelengths to be spectrally separated. In addition, in such a case, it is not necessary to use all of the window portions. For example, in a case of capturing an image spectrally separated in three wavelengths in the filter unit provided with four window portions in the filter frame, one window portion is used to block light.

(5) Second Optical Filter

In the above-mentioned embodiment, the case where a band-stop filter having a finite width in the light absorption band is used as the second optical filter has been described as an example. However, an optical filter used as the second optical filter is not limited thereto. In addition, for example, it may be possible to use an optical filter having characteristics of absorbing light having a specific wavelength or more or light having a specific wavelength or less and transmitting light in other wavelength regions. As the type of optical filter, a sharp-cut filter (SCF) can be exemplified. The sharp-cut filter will also be referred to as a long-pass filter or the like.

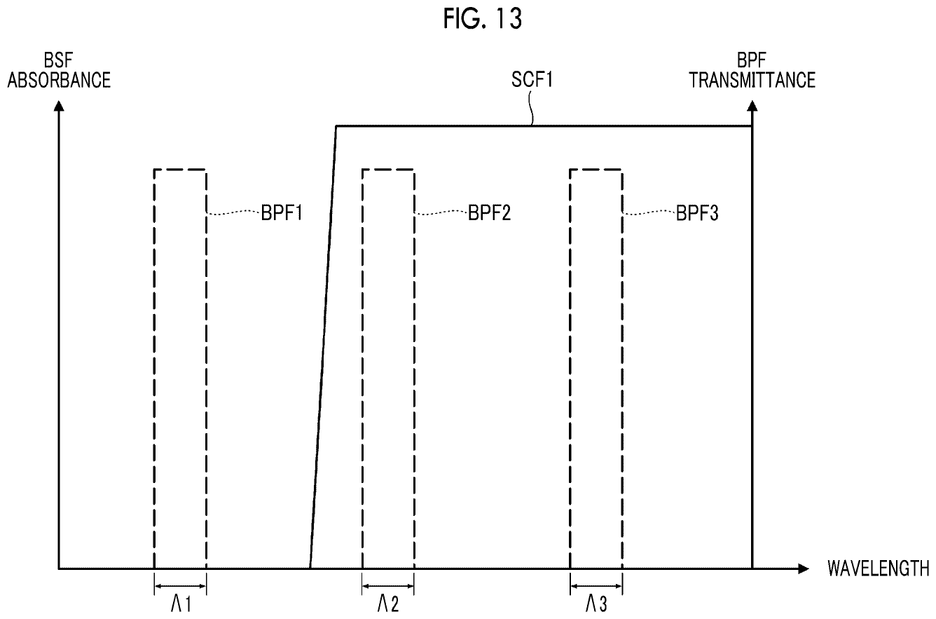

FIG. 13 is a graph showing an example of the absorbance characteristics of the sharp-cut filter.

FIG. 13 shows an example of the absorbance characteristics of the sharp-cut filter disposed in the first window portion in the filter unit (filter unit having three window portions) shown in FIG. 6. That is, the example of the absorbance characteristics of the sharp-cut filter used in combination with the first band-pass filter 144A is shown.

In the drawing, a solid line graph represented by the reference numeral SCF1 indicates the absorbance characteristics of the sharp-cut filter.

In addition, in the drawing, a broken line graph represented by the reference numeral BPF1 indicates the transmittance characteristics of the first band-pass filter 144A. Further, a broken line graph represented by the reference numeral BPF2 indicates the transmittance characteristics of the second band-pass filter 144B. Furthermore, a broken line graph represented by the reference numeral BPF3 indicates the transmittance characteristics of the third band-pass filter 144C.

As shown in FIG. 13, the sharp-cut filter of the present example has characteristics of absorbing light on the long wavelength side with a wavelength as a boundary between the wavelength region transmitted through the first band-pass filter 144A (first light transmission band Λ1) and the wavelength region transmitted through the second band-pass filter 144B (second light transmission band Λ2). As a result, the light having the wavelength region (first light transmission band Λ1), which is transmitted through the first band-pass filter 144A, can be transmitted. In addition, the light having the wavelength region (second light transmission band Λ2), which is transmitted through the second band-pass filter 144B, and the light having the wavelength region (third light transmission band Λ3), which is transmitted through the third band-pass filter 144C, can be absorbed.

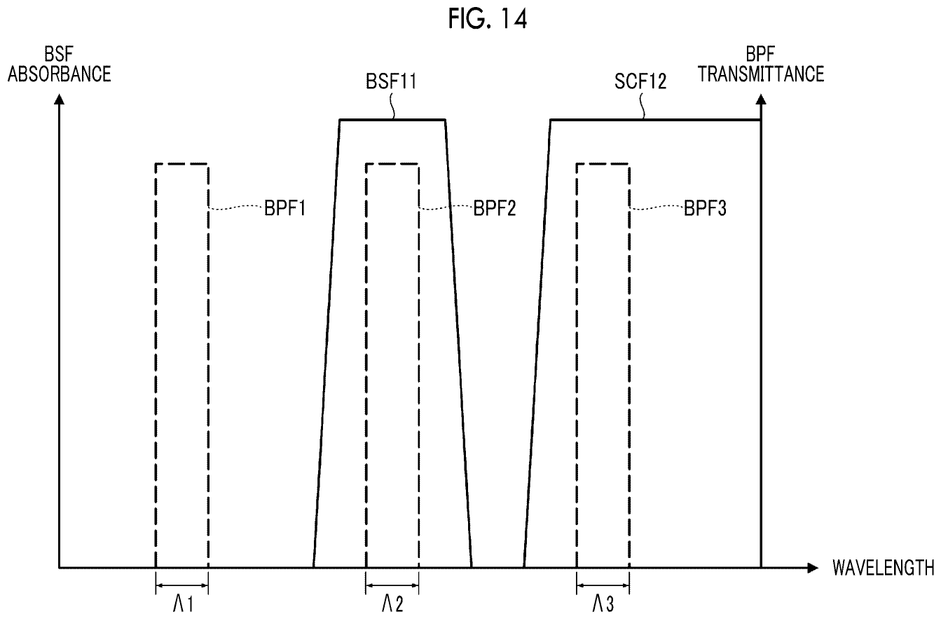

FIG. 14 is a graph showing an example of absorbance characteristics of a second optical filter in a case where the band-stop filter and the sharp-cut filter are combined to form one second optical filter.

FIG. 14 shows an example of the absorbance characteristics of the second optical filter disposed in the first window portion in the filter unit shown in FIG. 6.

In the drawing, a broken line graph represented by the reference numeral BPF1 indicates the transmittance characteristics of the first band-pass filter 144A. Further, a broken line graph represented by the reference numeral BPF2 indicates the transmittance characteristics of the second band-pass filter 144B. Furthermore, a broken line graph represented by the reference numeral BPF3 indicates the transmittance characteristics of the third band-pass filter 144C.

In the present example, the second optical filter having desired absorbance characteristics as a whole is realized by combining the band-stop filter and the sharp-cut filter. The band-stop filter absorbs the light in the wavelength region (second light transmission band Λ2), which is transmitted through at least the second band-pass filter 144B, and transmits light in the other wavelength region. The sharp-cut filter absorbs the light having the wavelength region (third light transmission band Λ3), which is transmitted through at least the third band-pass filter 144C, and transmits the light in the other wavelength region.

In FIG. 14, a solid line graph represented by the reference numeral BSF11 indicates the absorbance characteristics of the band-stop filter. The band-stop filter has a light absorption band having a finite width in a wavelength region including the second light transmission band Λ2.

Further, in FIG. 14, a solid line graph represented by the reference numeral SCF12 indicates the absorbance characteristics of the sharp-cut filter. The sharp-cut filter has characteristics of absorbing light on a long wavelength side with a wavelength, which is set on a shorter wavelength side than the third light transmission band Λ3, as a boundary.

As described above, the second optical filter having desired absorbance characteristics can be realized even by combining the band-stop filter and the sharp-cut filter.

In the present example, a case where the band-stop filter and the sharp-cut filter are combined to realize the second optical filter having a desired absorbance characteristic has been described as an example. However, in a case where two sharp-cut filters are combined, it is also possible to realize the second optical filter having desired absorbance characteristics.

[Optical Characteristics of Second Optical Filter]

Here, preferable optical characteristics necessary for the second optical filter will be described.

(1) Absorbance Characteristics of Second Optical Filter

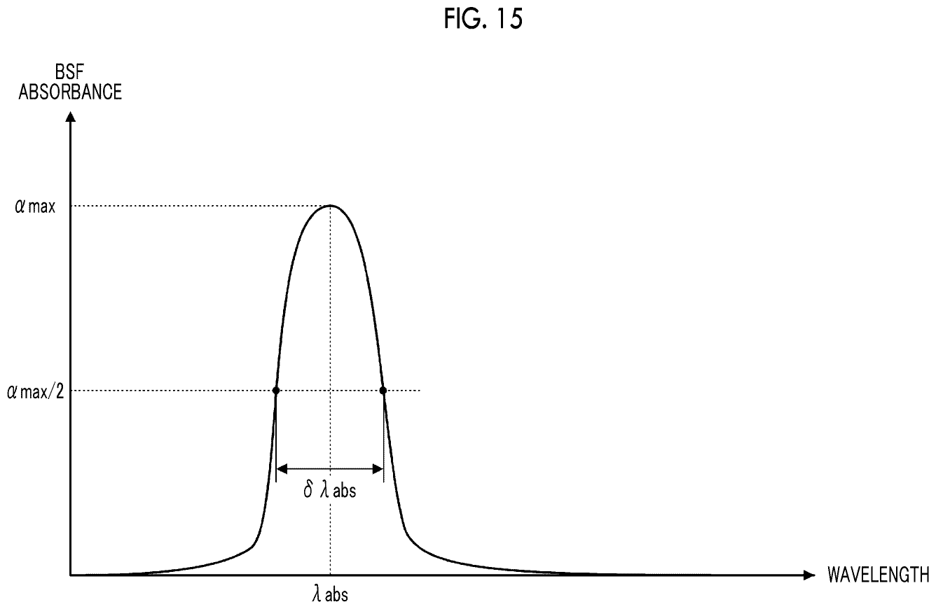

FIG. 15 is a graph showing an example of the absorbance characteristics of the second optical filter.

FIG. 15 shows an example of the preferable absorbance characteristics in a case where the band-stop filter having the light absorption band with the finite width is used as the second optical filter.

In a so-called visible region to a near infrared region (400 to 1000 [nm]), a wavelength, at which the absorbance is a peak, (absorbance peak wavelength) is denoted by λabs, and an absorbance at the absorbance peak wavelength λabs is denoted by αmax.

It is preferable that the second optical filter has an absorbance αmax of 0.8 or more at the absorbance peak wavelength λabs (αmax≥0.8).

In the optical filter, in a case where an absorbance thereof is denoted by α, a transmittance thereof is denoted by τ, and a reflectance thereof is denoted by ρ, there is a relationship of α+τ+ρ=1. In a case where light having a wavelength near the absorbance peak wavelength λabs is incident on the second optical filter, the light not absorbed is divided into transmitted light and reflected light. However, in a case where the reflective member is present on the rear side in the traveling direction of the light, the transmitted component thereof is also reflected. In a case where the absorbance a is ensured at a certain level or higher, it is possible to reduce a reflected component of light including a reflected component caused by the transmission.

FIG. 15 shows an example of the band-stop filter. However, similarly, also in a case where the sharp-cut filter is used as the second optical filter, it is preferable that the absorbance αmax at the absorbance peak wavelength λabs is equal to or greater than 0.8.

In addition, in a case where a band-stop filter having a finite width in the light absorption band is used as the second optical filter, it is preferable to further satisfy the following conditions. That is, in a case where a width of a wavelength at which 50% (αmax/2) of the absorbance αmax at the absorbance peak wavelength λabs is denoted by δλabs, it is preferable that the width δλabs is equal to or greater than 20 nm and equal to or less than 200 nm (20[nm]≤δλabs≤200 [nm]). The width of the wavelength in which the absorbance at the absorbance peak wavelength is 50% (half value) refers to a bandwidth between the long wavelength side and the short wavelength side in which the absorbance is a value of 50% of the peak value (so-called full width at half maximum).

In a case where the wavelength region to be absorbed is excessively narrow, the wavelength to be absorbed is not sufficiently absorbed, and it is difficult to obtain a sufficient effect of suppressing ghosts and flares. In contrast, in a case where the wavelength region to be absorbed is excessively wide, a wavelength originally desired to be used is also absorbed, which causes reduction in brightness. Therefore, in a case where the band-stop filter is used as the second optical filter, it is preferable that the full width at half maximum (6λabs) thereof is equal to or greater than 20 nm and equal to or less than 200 nm.

(2) Transmittance Characteristics of Second Optical Filter

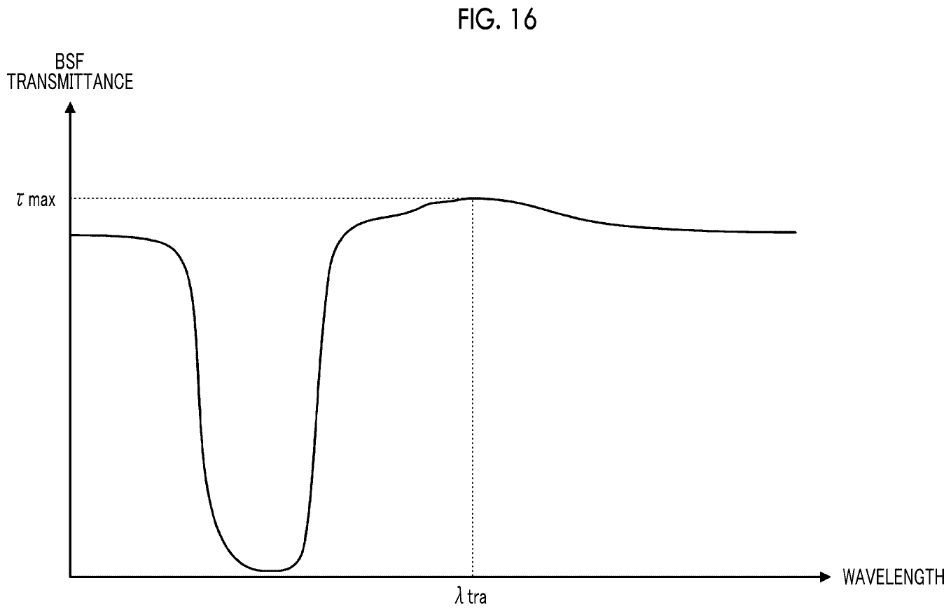

FIG. 16 is a graph showing an example of the transmittance characteristics of the second optical filter.

FIG. 16 shows an example of preferable transmittance characteristics in a case where the band-stop filter having the finite width of the light absorption band is used as the second optical filter.

In a so-called visible region to a near infrared region (400 to 1000 [nm]), a wavelength at which the transmittance is a peak (transmittance peak wavelength) is denoted by λtra, and a transmittance at the transmittance peak wavelength λtra is denoted by τmax.

It is preferable that the second optical filter has a transmittance τmax of 0.8 or more at the transmittance peak wavelength λtra (τmax≥0.8).

The second optical filter is made to have absorbance characteristics in λabs for the purpose of preventing reflected light. However, in a case where the second optical filter has a high transmittance in the vicinity of the wavelength actually used (a wavelength to be transmitted), it is possible to suppress reduction in brightness.

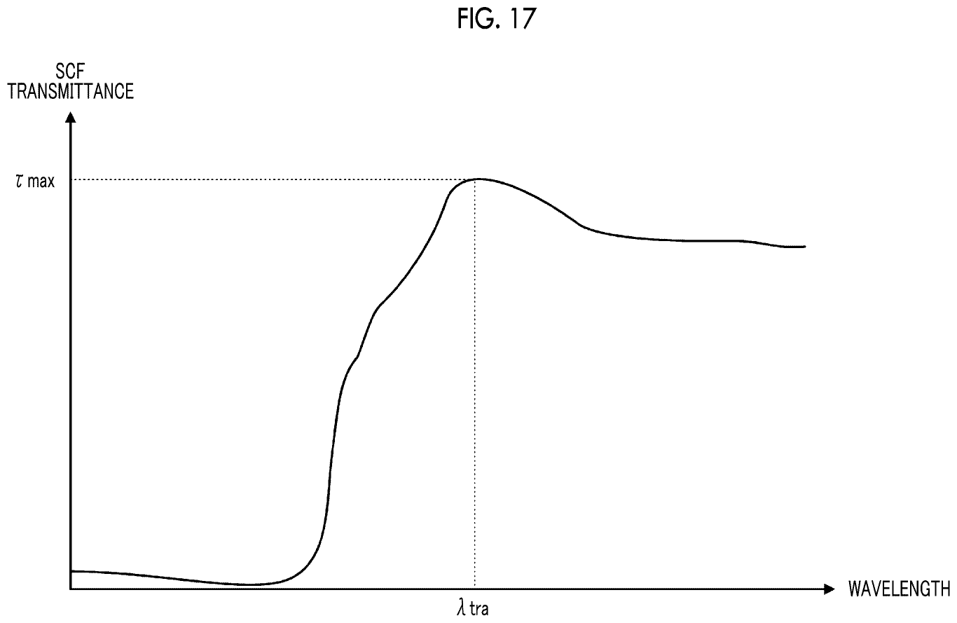

FIG. 17 is a graph showing another example of the transmittance characteristics of the second optical filter.

FIG. 17 shows an example of preferable transmittance characteristics in a case where the sharp-cut filter is used as the second optical filter.

In a case where the sharp-cut filter is used as the second optical filter, it is preferable that the transmittance τmax at the transmittance peak wavelength λtra is equal to or greater than 0.8.

(3) Reflectance Characteristics of Second Optical Filter

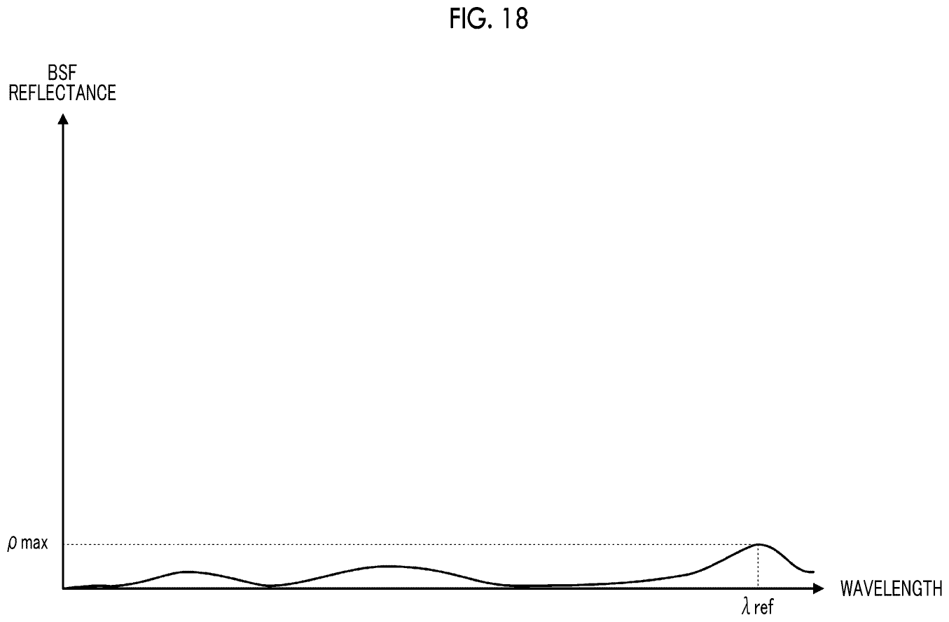

FIG. 18 is a graph showing an example of the reflectance characteristics of the second optical filter.

In a so-called visible region to a near infrared region (400 to 1000 [nm]), a wavelength at which the reflectance is a peak (reflectance peak wavelength) is denoted by λref, and a transmittance at the reflectance peak wavelength λref is denoted by ρmax.

It is preferable that the reflectance ρmax of the second optical filter at the reflectance peak wavelength λref is less than 0.1 (ρmax<0.1).

By suppressing the reflectance of the second optical filter, it is possible to suppress occurrence of ghosts and flares caused by reflection by the second optical filter.

(4) Transmittance Characteristics of Second Optical Filter Used in Combination with First Optical Filter

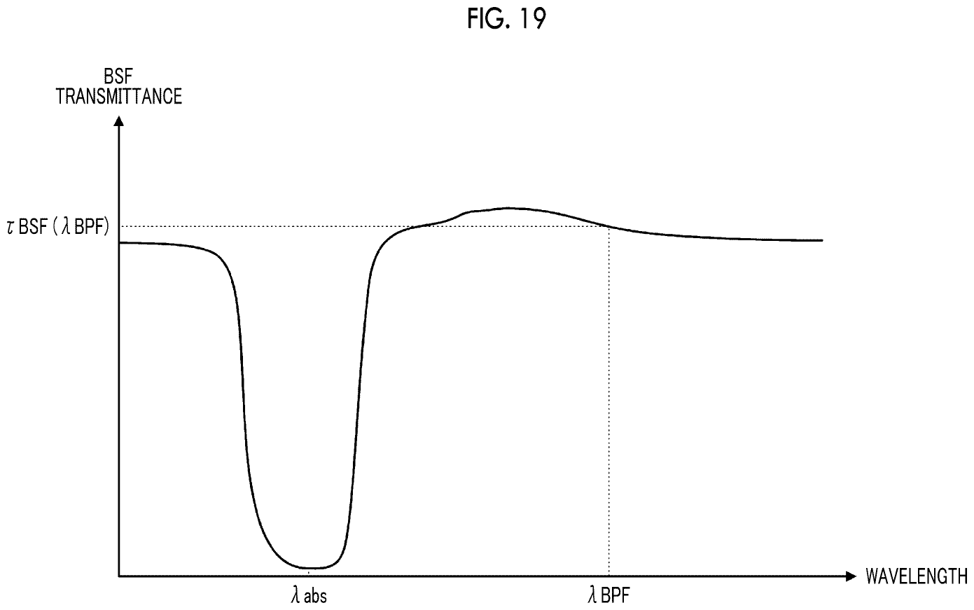

FIG. 19 is a graph showing an example of the transmittance characteristics of the second optical filter used in combination with the first optical filter.

FIG. 19 shows an example of a case where the band-pass filter is used as the first optical filter and the band-stop filter is used as the second optical filter.

A wavelength (transmittance peak wavelength) at which the transmittance of the band-pass filter is a peak in the so-called visible region to near infrared region (400 to 1000 [nm]) is denoted by λBPF. In the band-stop filter, the transmittance at a wavelength corresponding to the transmittance peak wavelength λBPF is denoted by τBSF(λBPF).

In the band-stop filter as the second optical filter, it is preferable that the transmittance τBSF(λBPF) at the wavelength corresponding to the transmittance peak wavelength λBPF is equal to or greater than 0.8 (τBSF(λBPF)≥0.8).

In a case where the first optical filter is used in combination with the first optical filter, the transmittance of the first optical filter in the wavelength region corresponding to the light transmission band is increased. Thereby, it is possible to suppress reduction in brightness at a wavelength actually used.

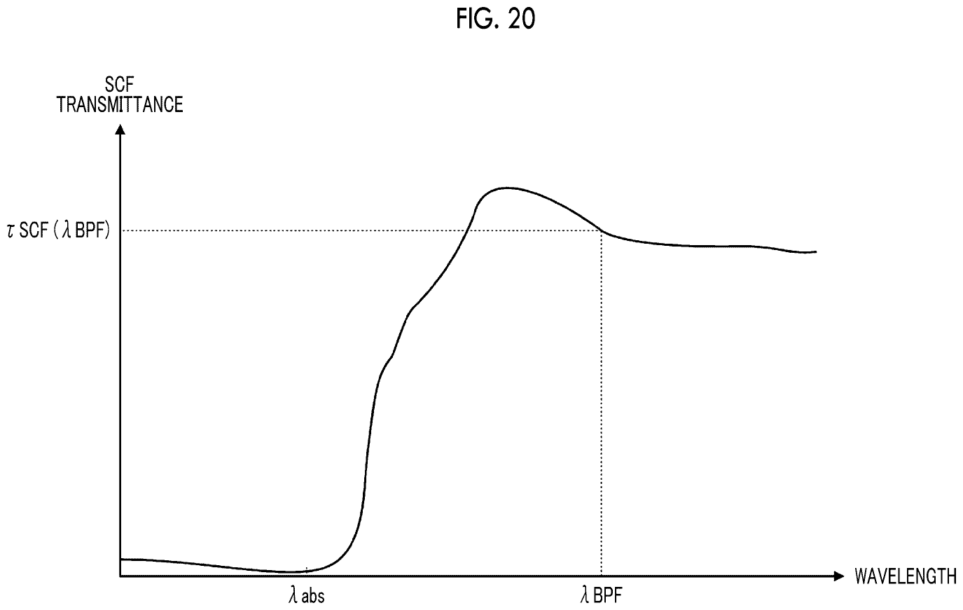

FIG. 20 is a graph showing another example of the transmittance characteristics of the second optical filter used in combination with the first optical filter.

FIG. 20 shows an example of a case where the band-pass filter is used as the first optical filter and the sharp-cut filter is used as the second optical filter.

In the sharp-cut filter, the transmittance at a wavelength corresponding to the transmittance peak wavelength λBPF is denoted by τSCF(λBPF).

In a case where the sharp-cut filter is used as the second optical filter, it is preferable that the transmittance τSCF(λBPF) at the wavelength corresponding to the transmittance peak wavelength λBPF is equal to or greater than 0.8 (τSCF(λBPF)≥0.8). By increasing the transmittance of the first optical filter in the wavelength region corresponding to the light transmission band, it is possible to suppress reduction in brightness at a wavelength actually used.

(5) Transmittance Characteristics of Second Optical Filter Disposed in Each Region, in Imaging Lens in which Pupil Region is Divided into Plurality of Regions

In the imaging lens in which the pupil region is divided into a plurality of regions, the transmittance characteristics of the second optical filter disposed in each region are set as follows.

Here, it is assumed that the pupil region is divided into three parts. That is, it is assumed that the optical path is divided into three parts. In such a case, the filter unit is provided with the three window portions.

Further, here, a case where the band-pass filter is used as the first optical filter and a band-stop filter is used as the second optical filter will be described as an example.

Assuming that j=1, 2, and 3, the transmittance peak wavelength of the band-pass filter which is disposed in the j-th window portion is denoted by λBPFj.

Assuming that i=1, 2, or 3, the absorbance of the band-stop filter which is disposed in the i-th window portion at the wavelength λ is denoted by λBSFi(λ).

Assuming that i,j∈{1, 2, 3}, it is preferable that the band-stop filter which is disposed in each window portion has absorbance characteristics that satisfy the following conditions.

αBSFi(λBPFj)≥0.8

Here, i≠j.

That is, it is preferable that the absorbance of the band-stop filter which is disposed in each window portion at the wavelength corresponding to the transmittance peak wavelength of the band-pass filter which is disposed in the other window portion (optical path) is equal to or greater than 0.8.

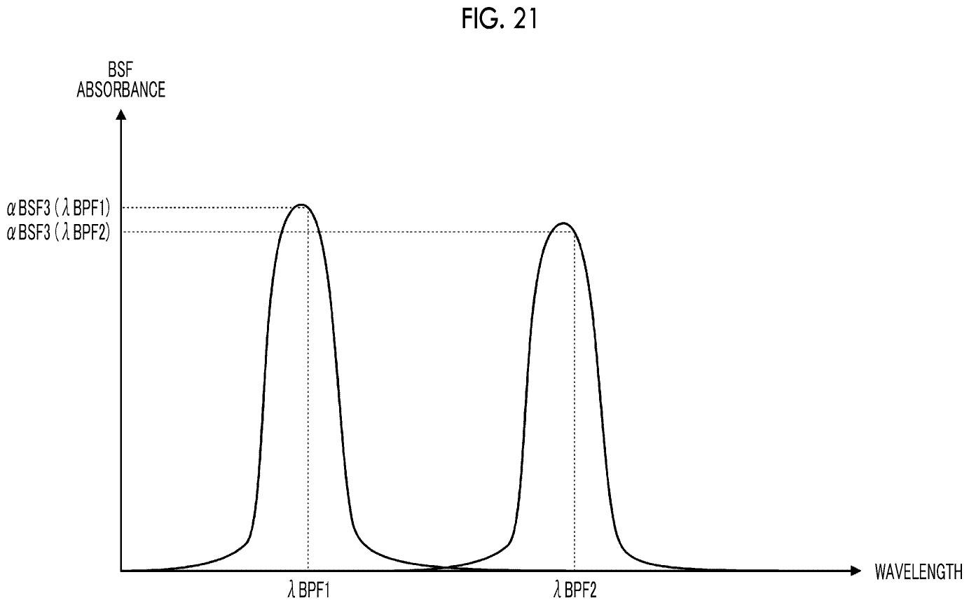

FIG. 21 is a graph showing an example of the transmittance characteristics of the band-stop filter used in combination with the band-pass filter in the third window portion.

As shown in the drawing, in the band-stop filter which is disposed in the third window portion, an absorbance αBSF3(λBPF1) at a wavelength, which corresponds to the transmittance peak wavelength λBPF1 of the band-pass filter disposed in the first window portion, and an absorbance αBSF3(λBPF2) at a wavelength, which corresponds to the transmittance peak wavelength λBPF2 of the band-pass filter disposed in the second window portion, are values close to the peak. That is, the band-stop filter has characteristics in which there are peaks in the vicinity of the wavelength corresponding to the transmittance peak wavelength λBPF1 of the band-pass filter disposed in the first window portion and in the vicinity of the wavelength corresponding to the transmittance peak wavelength λBPF2 of the band-pass filter disposed in the second window portion.

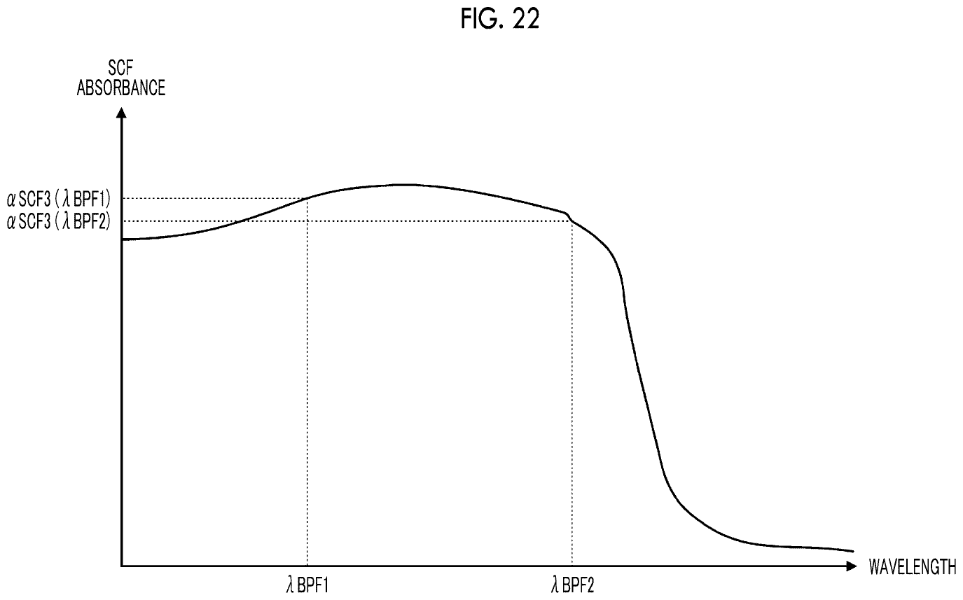

FIG. 22 is a graph showing an example of transmittance characteristics in a case where the sharp-cut filter is used as the second optical filter.

The transmittance peak wavelength of the band-pass filter which is disposed in the first window portion is denoted by λBPF1, and the transmittance peak wavelength of the band-pass filter which is disposed in the second window portion is denoted by λBPF2. In the sharp-cut filter which is disposed in the third window portion, an absorbance at a wavelength, which corresponds to the transmittance peak wavelength λBPF1 of the band-pass filter disposed in the first window portion, is denoted by αSCF3(λBPF1), and an absorbance at a wavelength, which corresponds to the transmittance peak wavelength λBPF2 of the band-pass filter disposed in the second window portion, is denoted by αSCF3(λBPF2).

As shown in the drawing, in the sharp-cut filter which is disposed in the third window portion, an absorbance αSCF3(λBPF1) at a wavelength, which corresponds to the transmittance peak wavelength λBPF1 of the band-pass filter disposed in the first window portion, and an absorbance αSCF3(λBPF2) at a wavelength, which corresponds to the transmittance peak wavelength λBPF2 of the band-pass filter disposed in the second window portion, are values close to the peak. That is, the band-stop filter has characteristics in which there are peaks in the vicinity of the wavelength corresponding to the transmittance peak wavelength λBPF1 of the band-pass filter disposed in the first window portion and in the vicinity of the wavelength corresponding to the transmittance peak wavelength λBPF2 of the band-pass filter disposed in the second window portion.

As described above, it is possible to suppress occurrence of ghosts and flares by using the second optical filter having a predetermined absorbance characteristic in each of the window portions (the second optical filter having an absorbance of a certain level or more at a wavelength corresponding to the transmittance peak wavelength of the first optical filter disposed in the other window portion or in the vicinity thereof). Specifically, the following effects are achieved.

The light, which passes through the first window portion and is reflected by the lens, the image sensor, or the like to be incident into the third window portion, will be considered.

The light, which passes through the first window portion, is restricted to light near the wavelength λBPF1 by the second optical filter which is disposed in the first window portion.

On the other hand, the second optical filter which is disposed in the third window portion has an absorbance which has a peak at the wavelength corresponding to the wavelength λBPF1 or near the wavelength.

Therefore, in a case where light which passes through the first window portion is reflected and is incident into the third window portion, most of the light is absorbed by the second optical filter which is disposed in the third window portion.

The same effects are achieved with respect to light which passes through the second window portion, is reflected by the lens, the image sensor, or the like, and is incident into the third window portion. Consequently, most of the light is absorbed by the second optical filter which is disposed in the third window portion.

As described above, most of the light which passes through the other window portions and is reflected by the lens, the image sensor, or the like to be incident into the third window portion is absorbed by the second optical filter which is disposed in the third window portion. Thereby, reflection by the first optical filter which is disposed in the third window portion or reflection by the second optical filter itself disposed in the third window portion is reduced, and occurrence of ghosts and flares is suppressed.

The same applies to light which passes through the other window portions, is reflected by the lens, the image sensor, or the like, and is incident into the first window portion and the second window portion. That is, most of the light is absorbed by the second optical filters disposed in the first window portion and the second window portion.

Next, light, which passes through the first window portion and is reflected by the lens, the image sensor, or the like to be incident into the first window portion, will be considered. That is, light, which is reflected and returns to the same window portion, will be considered.

As described above, the light, which passes through the first window portion, is restricted to the light near the wavelength λBPF1 by the second optical filter which is disposed in the first window portion. The first optical filter and the second optical filter, which are disposed in the first window portion, substantially transmit light near the wavelength λBPF1. Accordingly, the light is reflected again by the first optical filter and the second optical filter which is disposed in the first window portion. Consequently, the above-mentioned configuration does not contribute to an increase in occurrence of ghosts and flares.

The same applies to the light which passes through the second window portion, is reflected by the lens, the image sensor, or the like, and is incident into the second window portion, and the light which passes through the third window portion, is reflected by the lens, the image sensor, or the like, and is incident into the third window portion.

As described above, the second optical filter having a predetermined absorbance characteristic is disposed in the window portion in which the first optical filter is disposed. Thus, reflection by the first optical filter is reduced. Thereby, it is possible to achieve reduction in ghosts and flares as a whole of the optical system.

[Imaging Lens Used in Polarization Type Multispectral Camera System]

The multispectral camera system is a system which simultaneously captures images (multispectral images) spectrally separated in a plurality of wavelengths. The polarization type is a multispectral camera system of a method using polarization.

In the imaging lens used in the polarization type multispectral camera system, the polarization filter is disposed in each window portion of the filter unit. Here, a case of capturing an image spectrally separated in three wavelengths (three bands) will be described as an example.

The configuration of the imaging lens is the same as the configuration of the imaging lens of the above-mentioned embodiment except that a polarization filter is disposed in each window portion of the filter unit. Consequently, only the configuration of the filter unit will be herein described.

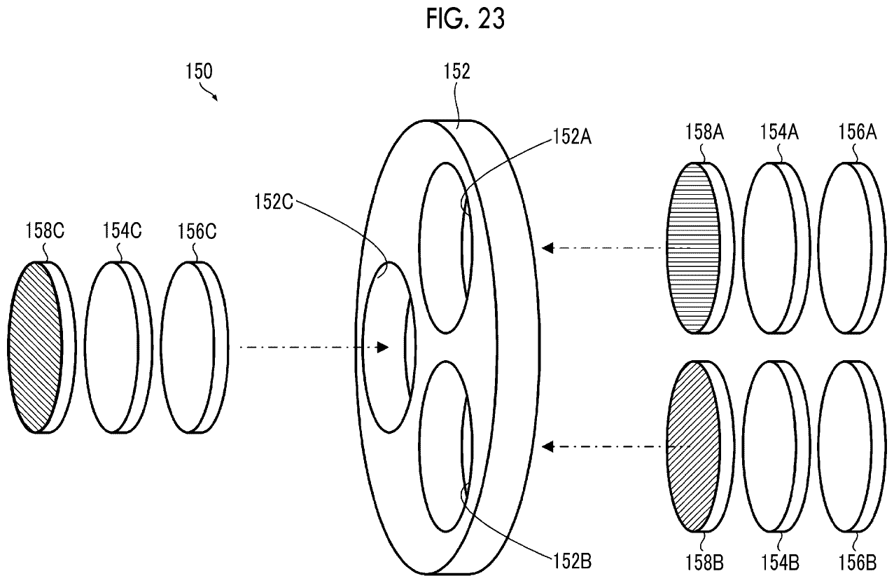

FIG. 23 is an exploded perspective view of a filter unit provided in an imaging lens for the polarization type multispectral camera system.

As shown in the drawing, the filter unit 150 of the present example comprises three window portions 152A, 152B, and 152C in a filter frame 152. The window portions 152A, 152B, and 153C are disposed at regular intervals on a concentric circle about the optical axis. Hereinafter, as necessary, the window portion 152A will be referred to as a first window portion 152A, the window portion 152B will be referred to as a second window portion 152B, and the window portion 152C will be referred to as a third window portion 152C. In such a manner, the three window portions 152A, 152B, and 152C are distinguished. In the imaging lens 100, the pupil region is divided into three regions by disposing the filter frame 152 at the pupil position or near the pupil position. That is, the optical path is divided into three parts.

The band-pass filters 154A, 154B, and 154C, the band-stop filters 156A, 156B, and 156C, and the polarization filters 158A, 158B, and 158C are respectively disposed in the window portions 152A, 152B, and 152C. In the filter unit 150 of the present example, the polarization filters 158A, 158B, and 158C, the band-pass filters 154A, 154B, and 154C, and the band-stop filters 156A, 156B, and 156C are disposed in order from the object side (front side) along the optical axis Z.

Hereinafter, as necessary, the band-pass filter 154A, which is disposed in the first window portion 152A, will be referred to as a first band-pass filter 154A, the band-pass filter 154B, which is disposed in the second window portion 152B, will be referred to as a second band-pass filter 154B, and the band-pass filter 154C, which is disposed in the third window portion 152C, will be referred to as a third band-pass filter 154C. In such a manner, the band-pass filters 154A, 154B, and 154C, which are disposed in the respective window portions 152A, 152B, and 152C, are distinguished. Further, the band-stop filter 156A, which is disposed in the first window portion 152A, will be referred to as the first band-stop filter 156A, the band-stop filter 156B, which is disposed in the second window portion 152B, will be referred to as the second band-stop filter 156B, and the band-stop filter 156C, which is disposed in the third window portion 152C, will be referred to as a third band-stop filter 156C. In such a manner, the band-stop filters 156A, 156B, and 156C, which are disposed in the respective window portions 152A, 152B, and 152C, are distinguished. Furthermore, the polarization filter 158A, which is disposed in the first window portion 152A, will be referred to as the first polarization filter 158A, the polarization filter 158B, which is disposed in the second window portion 152B, will be referred to as the second polarization filter 158B, and the polarization filter 158C, which is disposed in the third window portion 152C, will be referred to as the third polarization filter 158C. In such a manner, the polarization filters 158A, 158B, and 158C, which are disposed in the respective window portions 152A, 152B, and 152C, are distinguished.

The band-pass filters 154A, 154B, and 154C, which are disposed in the respective window portions 152A, 152B, and 152C, have light transmission bands different from each other. The light transmission band of the first band-pass filter 154A will be referred to as a first light transmission band Λ1. Further, the light transmission band of the second band-pass filter 154B will be referred to as a second light transmission band Λ2 (Λ1≠Λ2). Furthermore, the light transmission band of the third band-pass filter 154C will be referred to as a third light transmission band Λ3 (Λ1≠Λ3, Λ2≠Λ3). In the present example, the third light transmission band Λ3 is set on a longer wavelength side than the second light transmission band Λ2. Further, the second light transmission band Λ2 is set to be on a longer wavelength side than the first light transmission band Λ1. Furthermore, the reflective type band-pass filters are used as the band-pass filters 154A, 154B, and 154C.

The band-stop filters 156A, 156B, and 156C, which are disposed in the respective window portions 152A, 152B, and 152C, have characteristics of transmitting light in a wavelength region which is transmitted through the band-pass filters disposed in at least the same window portions. On the other hand, the band-stop filters have characteristics of absorbing light having the wavelength region which is transmitted through the band-pass filter disposed in at least one of the other window portions. Specifically, the band-stop filter is composed of an absorptive type band-stop filter having the following optical characteristics.

The first band-stop filter 146A has characteristics of transmitting light in the wavelength region (first light transmission band Λ1) which is transmitted through at least the first band-pass filter 144A. Meanwhile, the first band-stop filter 146A has characteristics of absorbing the light having the wavelength region (second light transmission band Λ2) which is transmitted through at least the second band-pass filter 144B and the light having the wavelength region (third light transmission band Λ3) which is transmitted through the third band-pass filter 144C (refer to FIG. 8).

The second band-stop filter 146B has characteristics of transmitting light in the wavelength region (second light transmission band Λ2) which is transmitted through at least the second band-pass filter 144B. Meanwhile, the second band-stop filter 146B has characteristics of absorbing light having the wavelength region (first light transmission band Λ1) which is transmitted through at least the first band-pass filter 144A and light having the wavelength region (third light transmission band Λ3) which is transmitted through the third band-pass filter 144C (refer to FIG. 9).

The third band-stop filter 146C has characteristics of transmitting light in a wavelength region (third light transmission band Λ3) which is transmitted through at least the third band-pass filter 144C. Meanwhile, the third band-stop filter 146C has characteristics of absorbing light having the wavelength region (first light transmission band Λ1) which is transmitted through at least the first band-pass filter 144A and light having the wavelength region (second light transmission band Λ2) which is transmitted through the second band-pass filter 144B (refer to FIG. 10).

The window portions 152A, 152B, and 152C are provided with respective polarization filters 158A, 158B, and 158C, which have different angles of transmission axes. The transmission axis of the polarization filter 158A provided in the first window portion 152A is set as the first angle β1. The transmission axis of the polarization filter 158B provided in the second window portion 152B is set as the second angle β2 (β2≠β1). The transmission axis of the polarization filter 158C provided in the third window portion 152C is set as the third angle β3 (β3≠β1, β3≠β1).

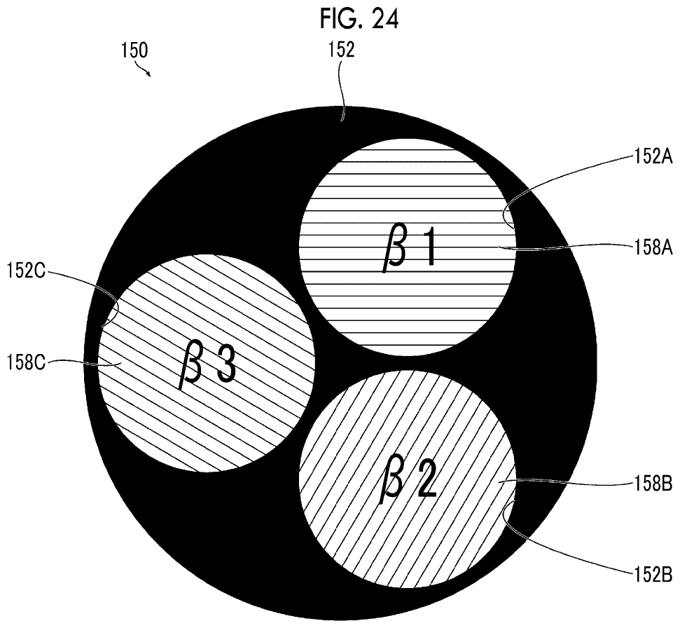

FIG. 24 is a diagram showing an example of the polarization filter provided in each window portion of the filter unit. FIG. 24 shows setting of the transmission axes of the polarization filters 158A, 158B, and 158C in a case where the filter unit 150 is viewed from a object side.

As shown in the drawing, in the filter unit 150 of the present embodiment, the transmission axis of the polarization filter 158A provided in the first window portion 152A is set to β1=0°, and the transmission axis of the polarization filter 158B provided in the second window portion 152B is set to β2=60°, and the transmission axis of the polarization filter 158C provided in the third window portion 152C is set to β3=120°.

It should be noted that the angle is 0° in a state where the transmission axis is parallel to the X axis, and is set as a plus (+) direction in a counterclockwise direction as viewed from an object side (front side). Consequently, the transmission axis of 60° is a state where the transmission axis is tilted by 60° in a counterclockwise direction with respect to the X axis. Further, the transmission axis of 120° is a state where the transmission axis is tilted by 120° in a counterclockwise direction with respect to the X axis. It should be noted that 120° is synonymous with −60°. That is, the transmission axis of 120° is a state where the transmission axis is tilted by 60° in a clockwise direction with respect to the X axis.

The X axis is an axis which is set on a plane orthogonal to the optical axis Z. In the plane orthogonal to the optical axis Z, an axis orthogonal to the X axis will be referred to as the Y axis. In the image sensor provided in the camera body of the multispectral camera system, the upper and lower sides of the light-receiving surface thereof are disposed in parallel with the X axis. Further, the left and right sides are disposed in parallel with the Y axis.

As the polarization filters 158A, 158B, and 158C, any of the reflective type or the absorptive type can be used. However, it is preferable to use the absorptive type from the viewpoint of suppressing ghosts.

Effects of the imaging lens of the present example configured as described above are as follows.

The optical path of the light, which is incident into the imaging lens, is divided into three parts by the filter unit 150. Then, the light passes through the first window portion 152A, the second window portion 152B, and the third window portion 152C, and reaches the image sensor (not shown in the drawing).

The light, which is incident into the first window portion 152A, passes through the first polarization filter 158A, the first band-pass filter 154A, and the first band-stop filter 156A disposed in the first window portion 152A, and is emitted from the first window portion 152A. In such a case, the light, which is incident into the first window portion 152A, passes through the first polarization filter 158A, the first band-pass filter 154A, and the first band-stop filter 156A in this order. First, the light passes through the first polarization filter 158A to be linearly polarized light of which an azimuthal angle is 0°. Next, the light, which passes through the first band-pass filter 154A, is restricted within the wavelength region Λ1. The first band-stop filter 156A absorbs light having the wavelength region Λ2 and the wavelength region Λ3, but transmits light having the wavelength region Λ1. Consequently, the light having the wavelength region Λ1, which passes through the first band-pass filter 154A, passes through the first band-stop filter 156A as it is. Therefore, the linearly polarized light having a wavelength region Λ1 and the azimuthal angle of 0° is emitted from the first window portion 152A.

The light, which is incident into the second window portion 152B, passes through the second polarization filter 158B, the second band-pass filter 154B, and the second band-stop filter 156B disposed in the second window portion 152B, and is emitted from the second window portion 152B. In such a case, the light, which is incident into the second window portion 152B, passes through the second polarization filter 158B, the second band-pass filter 154B, and the second band-stop filter 156B in this order. First, the light passes through the second polarization filter 158B to be linearly polarized light of which the azimuthal angle is 60°. Next, the light, which passes through the second band-pass filter 154B, is restricted within the wavelength region Λ2. The second band-stop filter 156B absorbs the light having the wavelength region Λ1 and the wavelength region Λ3, but transmits the light having the wavelength region Λ2. Consequently, the light having the wavelength region Λ2, which passes through the second band-pass filter 154B, passes through the second band-stop filter 156B as it is. Therefore, the linearly polarized light having the wavelength region Λ2 and the azimuthal angle of 60° is emitted from the second window portion 152B.

The light, which is incident into the third window portion 152C, passes through the third polarization filter 158C, the third band-pass filter 154C, and the third band-stop filter 156C disposed in the third window portion 152C, and is emitted from the third window portion 152C. In such a case, the light, which is incident into the third window portion 152C, passes through the third polarization filter 158C, the third band-pass filter 154C, and the third band-stop filter 156C in this order. First, the light passes through the third polarization filter 158C to be linearly polarized light of which the azimuthal angle is 120°. Next, the light, which passes through the third band-pass filter 154C, is restricted within the wavelength region Λ2. The third band-stop filter 156C absorbs the light having the wavelength region Λ1 and the wavelength region Λ2, but transmits the light having the wavelength region Λ3. Consequently, the light having the wavelength region Λ3, which passes through the third band-pass filter 154C, passes through the third band-stop filter 156C as it is. Therefore, the linearly polarized light having the wavelength region Λ3 and the azimuthal angle of 120° is emitted from the third window portion 152C.

As described above, according to the imaging lens of the present example, the polarization filters 158A, 158B, and 158C are disposed in the respective window portions 152A, 152B, and 152C of the filter unit 150. Thereby, light in the predetermined polarization direction can be obtained from each of the window portions 152A, 152B, and 152C. It should be noted that the effect of suppressing ghosts and flares due to the disposition of the band-stop filters 156A, 156B, and 156C is the same as the effect of suppressing ghosts and flares in the imaging lens 100 of the above-mentioned embodiment.

In the present example, in each window portion, the band-pass filter, the band-stop filter, and the polarization filter are disposed in the order of the polarization filter, the band-pass filter, and the band-stop filter from the object side along the optical axis. However, the order in which the optical filters are disposed is not limited thereto. For example, the band-pass filter, the band-stop filter, and the polarization filter may be disposed in this order from the object side along the optical axis. Further, for example, the band-pass filter, the polarization filter, and the band-stop filter may be disposed in this order from the object side along the optical axis.

Further, it is preferable that the band-pass filter, the band-stop filter, and the polarization filter, which are disposed in the respective window portions, are disposed without an air layer interposed therebetween.

Further, as for the second optical filter, a sharp-cut filter can be used instead of the band-stop filter.

Further, the number of window portions (the number of divisions of the pupil region) provided in the filter unit is set in accordance with the number of wavelengths to be spectrally separated. For example, in a case of performing imaging by spectrally separating light into two wavelengths, at least two window portions are provided. Further, in a case of performing imaging by spectrally separating light into four wavelengths, at least four window portions are provided.

[Multispectral Camera System]

Next, a multispectral camera system using the imaging lens according to the present invention will be described.

As described above, the multispectral camera system is a system which simultaneously captures images spectrally separated into a plurality of wavelengths.

Here, an example of the polarization type multispectral camera system will be described. Further, a case of capturing an image spectrally separated in three wavelengths will be described as an example.

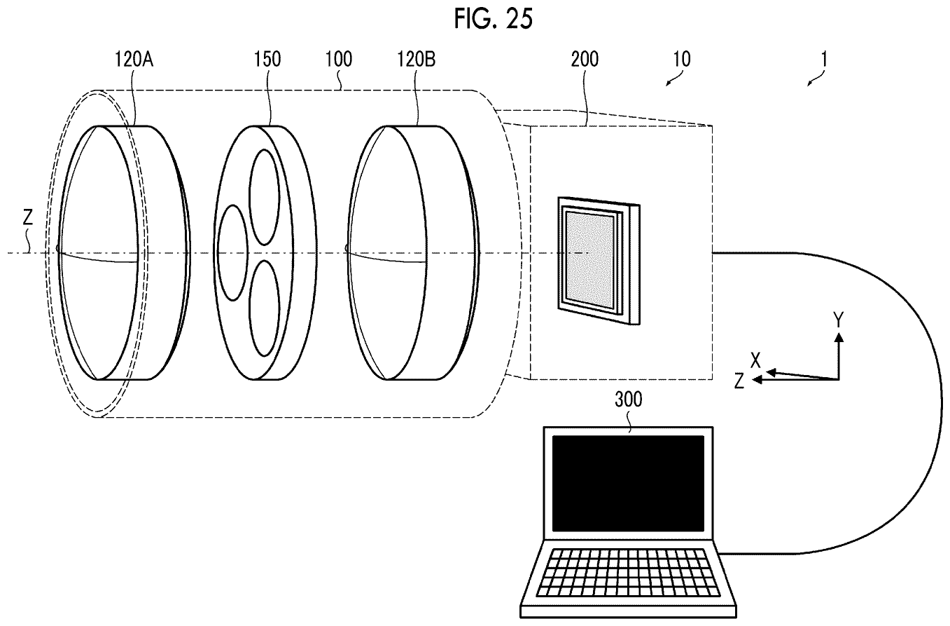

FIG. 25 is a diagram showing a schematic configuration of the multispectral camera system.

As shown in the drawing, the multispectral camera system 1 according to the present embodiment mostly is composed of a multispectral camera 10 and a signal processing device 300. The multispectral camera 10 is composed of the imaging lens 100 and a camera body 200. The multispectral camera 10 is an example of the imaging apparatus.

[Imaging Lens]

As the imaging lens 100, an imaging lens provided with the filter unit 150 shown in FIG. 23 is used. That is, an imaging lens is used, which has the filter unit 150 which has the three window portions 152A, 152B, and 152C in the filter frame 152 and in which the band-pass filters 154A, 154B, and 154C, the band-stop filters 156A, 156B, and 156C, and the polarization filters 158A, 158B, and 158C are disposed in the respective window portions 152A, 152B, and 152C.

[Camera Body]

As shown in FIG. 25, the camera body 200 has an image sensor 210. The image sensor 210 is disposed on the optical axis of the imaging lens 100, and receives light which passes through the imaging lens 100. The image sensor 210 is composed of a polarization image sensor. The polarization image sensor is an image sensor equipped with a polarizer, and the polarizer is provided for each pixel. The polarizer is provided, for example, between the microlens and the photodiode. It should be noted that since the type of polarization image sensor is well known (for example, WO2020/071253A, and the like), the details thereof will not be described.

The direction (angle of the transmission axis) of the polarizer equipped on the polarization image sensor is selected in accordance with the number of wavelengths to be imaged. In the present embodiment, images spectrally separated by three wavelengths are captured. In such a case, the polarization image sensor including the polarizers in at least three directions is used. In the present embodiment, the polarization image sensor including the polarizers in four directions is used.

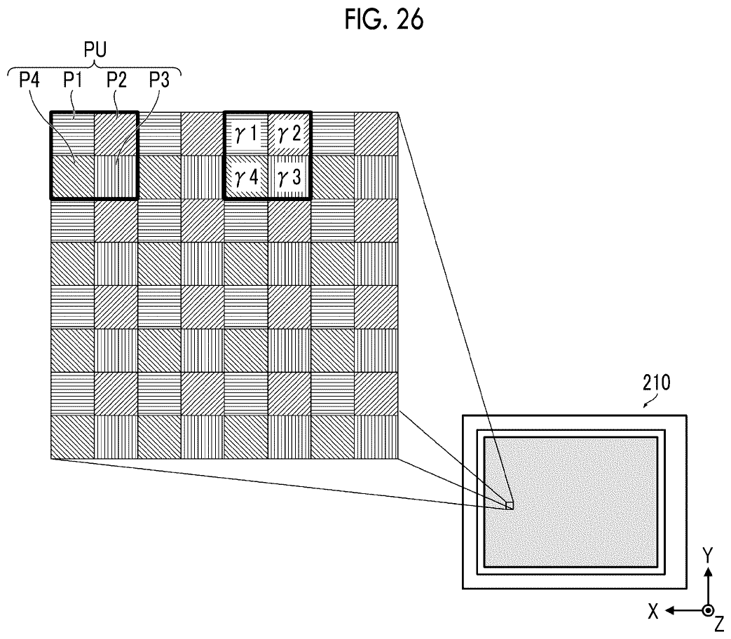

FIG. 26 is a diagram showing an example of disposition of the pixels and the polarizers in the polarization image sensor.

As shown in the drawing, four polarizers having different angles of the transmission axes are regularly disposed with respect to the pixels disposed in a matrix. A polarizer of which the angle of the transmission axis is γ1 is set as a first polarizer, a polarizer of which the angle of the transmission axis is γ2 is set as a second polarizer, a polarizer of which the angle of the transmission axis is γ3 is set as a third polarizer, and a polarizer of which the angle of the transmission axis is γ4 is set as a fourth polarizer. For example, in the present embodiment, the angle γ1 of the transmission axis of the first polarizer is set to 0°, the angle γ2 of the transmission axis of the second polarizer is set to 45°, the angle γ3 of the transmission axis of the third polarizer is set to 90°, and the angle γ4 of the transmission axis of the fourth polarizer is set to 135°.

A pixel P1 provided with the first polarizer will be referred to as a first pixel, a pixel P2 provided with the second polarizer will be referred to as a second pixel, a pixel P3 provided with the third polarizer will be referred to as a third pixel, and a pixel P4 provided with the fourth polarizer will be referred to as a fourth pixel. A 2×2 pixel group consisting of the first pixel P1, the second pixel P2, the third pixel P3, and the fourth pixel P4 will be referred to as one unit (pixel unit) PU, and the pixel unit PU is repeatedly disposed along the X axis and the Y axis.

In such a polarization image sensor equipped with the polarizers in four directions, it is possible to capture polarized images in four directions in one shot.

The image sensor 210 is composed of, for example, a complementary metal oxide semiconductor (CMOS) type including a driving unit, an analog to digital converter (ADC), a signal processing unit, and the like. In such a case, the image sensor 210 is driven by a built-in driving unit to operate. Further, a signal of each pixel is converted into a digital signal by the built-in ADC and output. Furthermore, the signal of each pixel is output after being subjected to correlation double sampling processing, gain processing, correction processing, and the like by a built-in signal processing unit. The signal processing may be performed after being converted into a digital signal, or may be performed before being converted into the digital signal.

In addition to the image sensor 210, the camera body 200 is provided with an output unit (not shown in the drawing) that outputs data of an image captured by the image sensor 210, a camera control unit (not shown in the drawing) that controls the overall operation of the camera body 200, and the like. The camera control unit is composed of, for example, a processor. The processor functions as the camera control unit by executing a predetermined control program.

In addition, the image data which is output from the camera body 200 is so-called RAW image data. That is, the image data is unprocessed image data. This RAW image data is processed by the signal processing device 300 to generate an image spectrally separated in a plurality of wavelengths.

[Signal Processing Device]

As described above, the signal processing device 300 processes the image data (RAW image data) which is output from the camera body 200 to generate an image spectrally separated in a plurality of wavelengths. More specifically, an image in the wavelength region corresponding to the light transmission band of the band-pass filter provided in each window portion of the imaging lens 100 is generated. In the present embodiment, an image having three wavelengths is generated, which consists of an image (first image) in a wavelength region (first wavelength region Λ1) corresponding to the first light transmission band Λ1, an image (second image) in a wavelength region (second wavelength region Λ2) corresponding to the second light transmission band Λ2, and an image (third image) in a wavelength region (third wavelength region Λ3) corresponding to the third light transmission band Λ3.

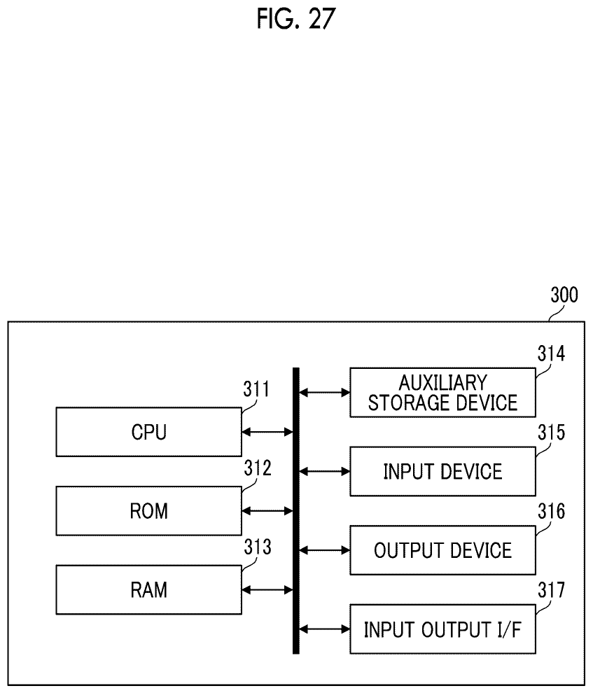

FIG. 27 is a diagram showing an example of a hardware configuration of the signal processing device.

As shown in the drawing, the signal processing device 300 is provided with a central processing unit (CPU) 311, a read only memory (ROM) 312, a random access memory (RAM) 313, an auxiliary storage device 314, an input device 315, an output device 316, an input output interface 317 and the like. Such a signal processing device 300 is composed of, for example, a general-purpose computer such as a personal computer.

In the signal processing device 300, the CPU 311, which is a processor, functions as the signal processing device by executing a predetermined program (signal processing program). The program executed by the CPU 311 is stored in the ROM 312 or the auxiliary storage device 314.

The auxiliary storage device 314 constitutes a storage unit of the signal processing device 300. The auxiliary storage device 314 is composed of, for example, a hard disk drive (HDD), a solid state drive (SSD), or the like.

The input device 315 constitutes an operating part of the signal processing device 300. The input device 315 is composed of, for example, a keyboard, a mouse, a touch panel, or the like.

The output device 316 constitutes a display unit of the signal processing device 300. The output device 316 is composed of, for example, a display such as a liquid crystal display or an organic light emitting diode display.

The input output interface 317 constitutes a connecting part of the signal processing device 300. The signal processing device 300 is connected to the camera body 200 through the input output interface 317.

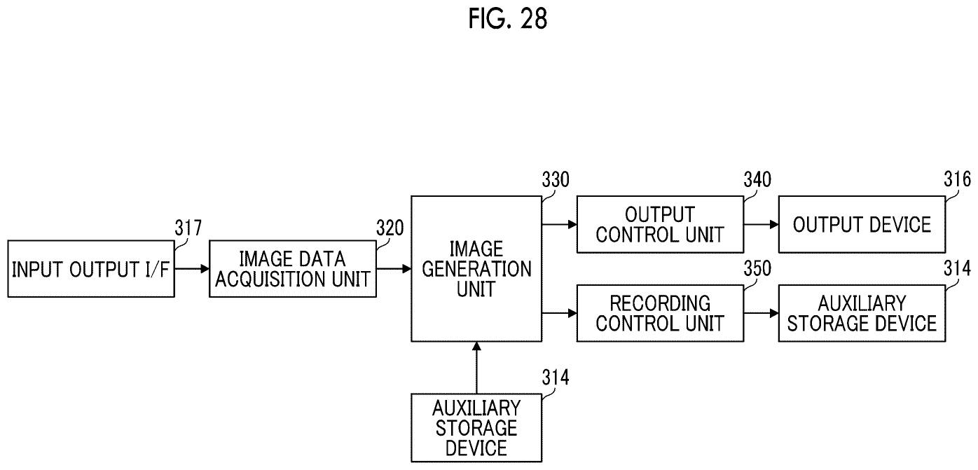

FIG. 28 is a block diagram of a main function of the signal processing device.

As shown in the drawing, the signal processing device 300 has functions of an image data acquisition unit 320, an image generation unit 330, an output control unit 340, a recording control unit 350, and the like. The functions are implemented by the CPU 311 executing a predetermined program.

The image data acquisition unit 320 acquires image data obtained through imaging from the camera body 200. As described above, the image data, which is acquired from the camera body 200, is RAW image data.

The image generation unit 330 performs predetermined signal processing on the image data acquired by the image data acquisition unit 320 to generate an image having a wavelength region corresponding to the light transmission band of the band-pass filter provided in each window portion of the imaging lens 100. In the present embodiment, the image of the first wavelength region Λ1 (first image), the image of the second wavelength region Λ2 (second image), and the image of the third wavelength region Λ3 (third image) are generated. The image generation unit 330 generates images in the respective wavelength regions Λ1, Λ2, and Λ3 by performing processing of removing interference in each pixel unit on the image data acquired by the image data acquisition unit 320. Hereinafter, this processing will be outlined.

As described above, in the polarization image sensor equipped with the polarizers in the four directions, it is possible to capture the polarized images in the four directions in one shot. The polarized images in the four directions include image components of the respective wavelength regions Λ1, Λ2, and Λ3 in a predetermined ratio (interference rate). The interference rate is determined and known by an angle of the transmission axis of the polarization filter provided in each window portion of the filter unit 120 and an angle of the transmission axis of the polarizer provided in each pixel. Then, by using information of the interference rate, it is possible to generate an image of each wavelength region.

In the images captured by the image sensor 210, it is assumed that a pixel value of the first pixel P1 is x1, a pixel value of the second pixel P2 is x2, a pixel value of the third pixel P3 is x3, and a pixel value of the fourth pixel P4 is x4.

Further, it is assumed that the pixel value of the corresponding pixel of the generated first image is X1, the pixel value of the corresponding pixel of the generated second image is X2, and the pixel value of the corresponding pixel of the generated third image is X3.

Assuming that a ratio of light received in the first wavelength region Λ1 by the first pixel P1 is b11, a ratio of light received in the second wavelength region Λ2 by the first pixel P1 is b12, a ratio of light received in the third wavelength region Λ3 by the first pixel P1 is b13, the following relationship is established between X1, X2, X3, and x1.

b11*X1+b12*X2+b13*X3=x1 (Expression 1)

Further, assuming that a ratio of light received in the first wavelength region Λ1 by the second pixel P2 is b21, a ratio of light received in the second wavelength region Λ2 by the second pixel P2 is b22, and a ratio of light received in the third wavelength region Λ3 by the second pixel P2 is b23, the following relationship is established between X1, X2, X3, and x2.

b21*X1+b22*X2+b23*X3=x2 (Expression 2)

Further, assuming that a ratio of light received in the first wavelength region Λ1 by the third pixel P3 is b31, a ratio of light received in the second wavelength region Λ2 by the third pixel P3 is b32, a ratio of light received in the third wavelength region Λ3 by the third pixel P3 is b33, the following relationship is established between X1, X2, X3, and x3.

b31*X1+b32*X2+b33*X3=x3 (Expression 3)

Further, assuming that a ratio of light received in the first wavelength region Λ1 by the fourth pixel P4 is b41, a ratio of light received in the second wavelength region Λ2 by the fourth pixel P4 is b42, a ratio of light received in the third wavelength region Λ3 by the fourth pixel P4 is b43, the following relationship is established between X1, X2, X3, and x4.

b41*X1+b42*X2+b43*X3=x4 (Expression 4)

Regarding X1, X2, and X3, the pixel values X1, X2, and X3 of the corresponding pixels of the first image, the second image, and the third image can be acquired by solving the simultaneous expressions of Expressions 1 to 4.

As described above, by using the information of the interference rate, it is possible to generate an image of each wavelength region from the image captured by the image sensor.

Here, the simultaneous expressions described above can be represented by an expression using a matrix. Further, X1, X2, and X3 can be calculated by multiplying both sides by an inverse matrix of the matrix. The signal processing device 300 holds each element of the inverse matrix as a coefficient group. The information of the coefficient group is stored in, for example, the auxiliary storage device 314. The image generation unit 330 acquires information about the coefficient group from the auxiliary storage device 314 and generates an image in each wavelength region.

The output control unit 340 controls outputs of the images (first image, second image, and third image) in the respective wavelength regions generated by the image generation unit 330. In the present embodiment, the output (display) onto the display, which is the output device 316, is controlled.

The recording control unit 350 controls recording of the image in each wavelength region generated by the image generation unit 330 in response to an instruction from the user. The generated images of the respective wavelength regions are recorded in the auxiliary storage device 314.

According to the multispectral camera system 1 of the present embodiment configured as described above, the images spectrally separated into three wavelengths can be simultaneously captured. The three wavelengths correspond to light transmission bands (first light transmission band Λ1, second light transmission band Λ2, and the light transmission band Λ3) of the band-pass filter 154A, 154B, and 154C disposed in the respective window portions 152A, 152B, and 152C of the imaging lens 100. Consequently, the band-pass filters, which are disposed in the respective window portions 152A, 152B, and 152C, are changed. Thereby, it is possible to capture a combined image having different wavelength regions.

[Modification Example of Multispectral Camera System]

[Application to Multispectral Camera System Other than Polarization Type]

The imaging lens according to the present invention can also be used in a multispectral camera system other than the polarization type. For example, the present invention can also be used for the multispectral camera system in which a directional sensor is used as an image sensor. The directional sensor is an image sensor having a function of selectively receiving luminous flux incident through an imaging lens through pupil division by using a microlens and a light blocking film (for example, refer to WO2019/073881A and the like). The directional sensor is also referred to as a pupil selectivity sensor or the like. In general, the polarization filter is not required in the imaging lens that is used in the multispectral camera system other than the polarization type.

[Imaging Lens and Camera Body]

The imaging lens and the camera body may have a structure integrated with each other. Further, for example, a mount may be provided such that the imaging lens is interchangeable with respect to the camera body.

[Image Sensor]

A color polarization image sensor can also be used as the image sensor. For example, in a case of capturing an image spectrally separated in four wavelengths, the color polarization image sensor is used. The color polarization image sensor is a polarization image sensor provided with color filters for the respective pixels. The color filter is disposed at a predetermined position in each pixel unit. For example, as in the image sensor shown in FIG. 26, in a case where one pixel unit PU is composed of four pixels P1 to P4, a first color filter (for example, a color filter that transmits light with a green wavelength region) is disposed in the first pixel P1, a second color filter (for example, a color filter that transmits light with a red wavelength region) is disposed in the second pixel P2, a third color filter (for example, a color filter that transmits light with a blue wavelength region) is disposed in the third pixel P3, and a fourth color filter (for example, a color filter that transmits light with an infrared region) is disposed in the fourth pixel P4. The color filter is disposed, for example, between the microlens and the polarizer, in each pixel.

In a case where the color polarization image sensor is used, an interference rate is obtained by further adding the information of the spectral transmittance of the color filter provided for each pixel.

[Signal Processing Device]

In the multispectral camera system of the above-mentioned embodiment, the camera body and the signal processing device are separately configured, but the camera body may be provided with the functions of the signal processing device. Further, in such a case, the camera body may be configured to include only the signal processing functions.

Further, various functions included in the signal processing device are implemented by various processors. The various processors include: a CPU and/or a graphic processing unit (GPU) as a general-purpose processor which functions as various processing units by executing programs; a programmable logic device (PLD) as a processor capable of changing a circuit configuration after manufacturing a field programmable gate array (FPGA); a dedicated electrical circuit as a processor, which has a circuit configuration specifically designed to execute specific processing, such as an application specific integrated circuit (ASIC); and the like. Program is synonymous with software.

One processing unit may be composed of one of these various processors, or may be composed of two or more processors of the same type or different types. For example, one processing unit may be composed of a plurality of FPGAs or of a combination of a CPU and an FPGA. Further, the plurality of processing units may be composed of one processor. As an example of the plurality of processing units composed of one processor, first, as represented by computers used for a client, a server, and the like, there is a form in which one processor is composed of a combination of one or more CPUs and software and this processor functions as a plurality of processing units. Second, as represented by a system on chip (SoC), there is a form in which a processor that realizes the functions of the whole system including a plurality of processing units with a single integrated circuit (IC) chip is used. As described above, the various processing units are configured by using one or more of the various processors as a hardware structure.

[Application to Other Lens Devices and Imaging Apparatuses]

The present invention can also be applied to a lens device used in an imaging apparatus other than the multispectral camera. The imaging apparatus also includes an imaging apparatus incorporated in other equipment. For example, a digital camera incorporated in a smartphone, a personal computer, or the like is also included. Further, the present invention can also be applied to a lens device used in an optical device other than the imaging apparatus.

### EXPLANATION OF REFERENCES

1: multispectral camera system
10: multispectral camera
100: imaging lens
110: lens barrel
120: filter unit
120A: lens group (first lens group)
120B: lens group (second lens group)
130: filter unit
132: filter frame
132A: window portion (first window portion)
132B: window portion (second window portion)
134A: band-pass filter (first band-pass filter)
134B: band-pass filter (second band-pass filter)
136A: band-stop filter (first band-stop filter)
136B: band-stop filter (second band-stop filter)
140: filter unit
142: filter frame
142A: window portion (first window portion)
142B: window portion (second window portion)
142C: window portion (third window portion)
144A: band-pass filter (first band-pass filter)
144B: band-pass filter (second band-pass filter)
144C: band-pass filter (third band-pass filter)
146A: band-stop filter (first band-stop filter)
146B: band-stop filter (second band-stop filter)
146C: band-stop filter (third band-stop filter)
150: filter unit
152: filter frame
152A: window portion (first window portion)
152B: window portion (second window portion)
152C: window portion (third window portion)
154A: band-pass filter (first band-pass filter)
154B: band-pass filter (second band-pass filter)
154C: band-pass filter (third band-pass filter)
156A: band-stop filter (first band-stop filter)
156B: band-stop filter (second band-stop filter)
156C: band-stop filter (third band-stop filter)
158A: polarization filter (first polarization filter)
158B: polarization filter (second polarization filter)
158C: polarization filter (third polarization filter)
200: camera body
210: image sensor
300: signal processing device
311: CPU
312: ROM
314: auxiliary storage device
315: input device
316: output device
317: input output interface
320: image data acquisition unit
330: image generation unit
340: output control unit
350: recording control unit
P1: pixel (first pixel)
P2: pixel (second pixel)
P3: pixel (third pixel)
P4: pixel (fourth pixel)
PU: pixel unit
Z: optical axis
β1: angle of transmission axis of polarization filter provided in first window portion
β2: angle of transmission axis of polarization filter provided in second window portion
β3: angle of transmission axis of polarization filter provided in third window portion
Λ1: light transmission band of first band-pass filter (first light transmission band)
Λ2: light transmission band of second band-pass filter (second light transmission band)
Λ3: light transmission band of third band-pass filter (third light transmission band)
γ1: angle of transmission axis of first polarizer
γ2: angle of transmission axis of second polarizer
γ3: angle of transmission axis of third polarizer
γ4: angle of transmission axis of fourth polarizer
λBPF: transmittance peak wavelength of band-pass filter
λBPF1: transmittance peak wavelength of band-pass filter disposed in first window portion
λBPF2: transmittance peak wavelength of band-pass filter disposed in second window portion
λabs: absorbance peak wavelength of band-stop filter
λref: reflectance peak wavelength of band-stop filter
λtra: transmittance peak wavelength of band-stop filter
αmax: absorbance at absorbance peak wavelength λabs
ρmax: transmittance at reflectance peak wavelength λref
τBSF(λBPF): transmittance at wavelength corresponding to transmittance peak wavelength λBPF
τSCF(λBPF): transmittance at wavelength corresponding to transmittance peak wavelength λBPF
τmax: transmittance at transmittance peak wavelength λtra
αBSF3(λBPF1): absorbance at wavelength corresponding to transmittance peak wavelength λBPF1
αBSF3(λBPF2): absorbance at wavelength corresponding to transmittance peak wavelength λBPF2
BPF1: graph showing a transmittance characteristics of first band-pass filter
BPF2: graph showing transmittance characteristics of second band-pass filter
BPF3: graph showing transmittance characteristics of third band-pass filter
BSF1: graph showing absorbance characteristics of first band-stop filter
BSF2: graph showing absorbance characteristics of second band-stop filter
BSF21: graph showing absorbance characteristics of first second band-stop filter
BSF22: graph showing absorbance characteristics of second second band-stop filter
BSF3: graph showing absorbance characteristics of third band-stop filter
SCF1: graph showing absorbance characteristics of sharp-cut filter
BSF11: graph showing absorbance characteristics of band-stop filter
SCF12: graph showing absorbance characteristics of sharp-cut filter

What is claimed is:

1. A lens device comprising:
a frame which is disposed on an optical path and has opening portions;
first optical filters which are disposed in at least two of the opening portions, and each of which has a light transmission band in a specific wavelength region;
second optical filters which are disposed in the opening portions in which the first optical filters are disposed, and disposed on an image side with respect to the first optical filters, wherein each of the second optical filters has a light absorption band in a wavelength region which is different from the light transmission band of each of the first optical filters; and
polarization filters which are disposed in the opening portions in which the first optical filters are disposed,
wherein at least two of the polarization filters disposed in the opening portions have angles of transmission axes different from each other.

2. The lens device according to claim 1,
wherein the first optical filters are reflective type band-pass filters.

3. The lens device according to claim 1,
wherein among the first optical filters disposed in the opening portions, a light transmission band of a first optical filter disposed in at least one opening portion is different from a light transmission band of a first optical filter disposed in another opening portion.

4. The lens device according to claim 3,
wherein the second optical filters disposed in the opening portions each have a light absorption band including the light transmission band of the first optical filter disposed in the at least one opening portion of the opening portions.

5. The lens device according to claim 3,
wherein the frame includes three or more opening portions,
the first optical filters are disposed in at least three opening portions,
the second optical filters are disposed in the at least three opening portions in which the first optical filters are disposed, and
the second optical filter disposed in at least one of the opening portions has a light absorption band including a light transmission band of the first optical filter disposed in another opening portion.

6. The lens device according to claim 3,
wherein the frame includes three or more opening portions,
the first optical filters are disposed in at least three opening portions,
the second optical filters are disposed in the at least three opening portions in which the first optical filters are disposed, and
the second optical filter disposed in at least one of the opening portions is formed by combining a plurality of optical filters having different light absorption bands from each other, and has a light absorption band including the light transmission band of the first optical filter disposed in another opening portion.

7. The lens device according to claim 1,
wherein each of the second optical filters has an absorbance of 0.8 or more at a wavelength at which the absorbance is a peak.

8. The lens device according to claim 1,
wherein each of the second optical filters has a transmittance of 0.8 or more at a wavelength at which the transmittance is a peak.

9. The lens device according to claim 1,
wherein each of the second optical filters has a reflectance of less than 0.1 at a wavelength at which the reflectance is a peak.

10. The lens device according to claim 1,
wherein a width of a wavelength, at which an absorbance of each of the second optical filters is 50% of a peak value, is equal to or greater than 20 nm.

11. The lens device according to claim 10,
wherein a width of a wavelength, at which an absorbance of each of the second optical filters is 50% of a peak value, is equal to or greater than 20 nm and equal to or less than 200 nm.

12. The lens device according to claim 1,
wherein each of the second optical filters has a layer including a coloring agent.

13. The lens device according to claim 1,
wherein each of the second optical filters has a transmittance of 0.8 or more at a wavelength corresponding to a wavelength at which a transmittance of the first optical filter is a peak.

14. The lens device according to claim 1,
wherein the second optical filters disposed in the opening portions each have an absorbance of 0.8 or more at a wavelength corresponding to a wavelength at which a transmittance of a first optical filter disposed in at least one of the opening portions is a peak.

15. An imaging apparatus comprising:
the lens device according to claim 1; and
a polarization image sensor that receives light which passes through the lens device.

16. A filter unit disposed in an optical path of a lens device, the filter unit comprising:
a frame that has a plurality of opening portions;
first optical filters that are disposed in at least two of the opening portions and each have a light transmission band in a specific wavelength region;
second optical filters that are disposed in the opening portions in which the first optical filters are disposed, and each have a light absorption band in a wavelength region which is different from the light transmission bands of the first optical filters; and
polarization filters that are disposed in the opening portions in which the first optical filters are disposed.

17. The filter unit according to claim 16,
wherein among the first optical filters disposed in the opening portions, a light transmission band of a first optical filter disposed in at least one opening portion is different from a light transmission band of a first optical filter disposed in another opening portion.

18. The filter unit according to claim 16,
wherein the second optical filters disposed in the opening portions each have a light absorption band including a light transmission band of a first optical filter disposed in at least one opening portion of the opening portions.

19. A filter unit disposed at a pupil position or near the pupil position on an optical path of a lens device, the filter unit comprising:
a frame having opening portions;
first optical filters which are disposed in at least two of the opening portions, and each of which has a light transmission band in a specific wavelength region; and
second optical filters which are disposed in the opening portions in which the first optical filters are disposed, and each of which has a light absorption band in a wavelength region which is different from the light transmission band of each of the first optical filters.

20. The filter unit according to claim 19,
wherein among the first optical filters disposed in the opening portions, a light transmission band of a first optical filter disposed in at least one opening portion is different from a light transmission band of a first optical filter disposed in another opening portion.

21. The lens device according to claim 19,
wherein the second optical filters disposed in the opening portions each have a light absorption band including a light transmission band of a first optical filter disposed in at least one opening portion of the opening portions.
